(19) United States
(12) Patent Application Publication
(10) Pub. No.: US 2017/0267348 A1
(43) Pub. Date: Sep. 21, 2017

(54) PACKAGING CONTAINER FOR DRONE DELIVERY

(71) Applicant: Flirtey Holdings, Inc., Reno, NV (US)

(72) Inventors: Matthew Sweeny, Reno, NV (US); John Elverum, Reno, NV (US); John Foggia, Reno, NV (US)

(21) Appl. No.: 15/612,989

(22) Filed: Jun. 2, 2017

Related U.S. Application Data
(63) Continuation-in-part of application No. 15/294,479, filed on Oct. 14, 2016.
Application No. 15/294,479 is a continuation-in-part of application No. 15/294,489, filed on Oct. 14, 2016.
Application No. 15/294,489 is a continuation-in-part of application No. 15/612,789, filed on Jun. 2, 2017.
(60) Provisional application No. 62/241,572, filed on Oct. 14, 2015.
(60) Provisional application No. 62/344,514, filed on Jun. 2, 2016.
(60) Provisional application No. 62/241,572, filed on Oct. 14, 2015.
(60) Provisional application No. 62/344,514, filed on Jun. 2, 2016.
(60) Provisional application No. 62/344,535, filed on Jun. 2, 2016.

(51) Int. Cl. B64D 1/22; B65D 25/22; B65D 5/50; B65D 81/38; B65D 5/10; A47J 47/14; B64C 39/02; B65D 25/34

(52) U.S. Cl. CPC B64D 1/22; B64C 39/024; B65D 25/22; B65D 25/34; B65D 81/3813; B65D 5/10; A47J 47/14; B65D 5/5007; B64C 2201/128

(57) ABSTRACT

Certain aspects of the technology disclosed involve a container for delivery by drone (e.g., an unmanned aerial vehicle). The container can include a coupling mechanism to lock and unlock a package attached to the drone based on a tension applied to the coupling mechanism. The package can include sidewalls affixed to a top wall. The sidewalls can include securing mechanisms to be secured to a bottom wall of the container. A rigid extremity can be a contiguous extension of any of the sidewalls and extend below a lower surface of the sidewalls. The rigid extremity can include a malleable contour proximate to a corner of the container. The malleable contour can extend from a base of the rigid extremity through the sidewall. An aperture in the top wall can be configured for a inserting member of a coupling mechanism.

### CROSS-REFERENCE TO RELATED APPLICATIONS

This application is a continuation-in-part of U.S. patent application Ser. No. 15/294,489, entitled “PARACHUTE CONTROL SYSTEM FOR AN UNMANNED AERIAL VEHICLE,” filed on Oct. 14, 2016, which claims the benefit of U.S. Provisional Application No. 62/241,572, entitled “PARACHUTE DEPLOYMENT SYSTEM FOR AN UNMANNED AERIAL VEHICLE,” filed on Oct. 14, 2015 (“'572 provisional application”) and U.S. Provisional Application No. 62/344,514, entitled “PARACHUTE DEPLOYMENT SYSTEM FOR AN UNMANNED AERIAL VEHICLE,” filed on Jun. 2, 2016 (“'514 provisional application”); and is a continuation-in-part of U.S. patent application Ser. No. 15/294,479, entitled “PARACHUTE DEPLOYMENT SYSTEM FOR AN UNMANNED AERIAL VEHICLE,” filed on Oct. 14, 2016, which claims the benefit of the '572 provisional application and the '514 provisional application; and is a continuation-in-part of U.S. patent application Ser. No. 15/612,789 entitled “PACKAGE DELIVERY MECHANISM IN AN UNMANNED AERIAL VEHICLE,” filed on Jun. 2, 2017, which claims the benefit of U.S. Provisional Application No. 62/344,535, entitled “PACKAGE DELIVERY MECHANISM IN AN UNMANNED AERIAL VEHICLE,” filed on Jun. 2, 2016; all of which are incorporated herein by reference in its entirety.

### TECHNICAL FIELD

The present application is related to a packaging container, and more specifically to a structure and method of using a packaging container for drone delivery.

### BACKGROUND

Delivery services provide delivery of goods (e.g., letters, packages, and parcels) to recipients across the country. A typical delivery service maintains a large fleet of vehicles, including airplanes and trucks to move packages between mail sorting facilities, and smaller vehicles for moving the packages from the sorting facilities to delivery destinations (e.g., a home or business). Such delivery services have some drawbacks and may not be efficient in catering to the needs of the consumers and/or business today. For example, such delivery services involve significant investments in terms of money to procure and maintain the fleet of vehicles, and to manage the human resource required to operate the fleet. Another problem with such delivery services is that they may be incapable of delivering the goods in a short span of time, e.g., in a few minutes or hours from the time the order is placed by the consumer, or even if a delivery service can promptly deliver goods, such prompt delivery can be very expensive for the consumer.

An unmanned aerial vehicle (UAV), such as a drone, can be used to deliver goods. The UAV can deliver goods promptly (e.g., within a few minutes or hours) from the time the order is placed by the consumer. UAV delivery services can overcome some of the problems discussed above with respect to the conventional delivery services, however other problems may arise. To deliver the packages, some UAVs carry the package to a delivery location, and land in the delivery location to drop the package. UAVs powered by a rotor or an impeller may be dangerous to pets or residents at the delivery location.

Some UAVs hover near the destination location at a safe distance from the ground, lower the package from the air onto the ground, e.g., by the means of a cable attached to the UAV, and leave the package on the ground. One problem with such delivery mechanism is that a coupling mechanism of the UAV for holding the package onto the cable and releasing the package from the cable when the package reaches the ground is very complex. The UAV has to have a separate communication cable running along the cable to which the package is attached, or have some other wireless means to communicate with the coupling mechanism to detach the package from the cable.

Another problem with such delivery mechanism is that when the cable is pulled by a person and/or an animal, or is tangled in an obstacle like a tree, it can bring the UAV down to the ground causing the UAV to be damaged and/or lost. It can also cause injury to the people and/or animals near the UAV. Thus, conventional aerial delivery device methods do not allow for safe, secure delivery of packages to delivery locations.

### SUMMARY

Certain aspects of the technology disclosed involve a container for delivery by drone (e.g., an unmanned aerial vehicle). The container can include a coupling mechanism to lock and unlock a package attached to the drone based on a tension applied to the coupling mechanism. The container can include one or more rigid extremities to, for example, elevate a delivered container above a surface and absorb an impact of a fall. The container can include internal packaging components configurable in one or more arrangements. The container can include a faraday cage, a thermal insulation layer, a hydrophobic coating, or any combination thereof.

The container can include a plurality of sidewalls affixed to a top wall, a bottom wall, and internal packaging components. Any of the sidewalls can include a securing mechanism to affix to a bottom wall. Any of the sidewalls can include one or more rigid extremities having a contiguous surface with the sidewall and extending below a lower surface of the sidewall. The rigid extremity can include a malleable contour proximate to corners of the container. The malleable contour can extend from a base of the rigid extremity through the sidewall such that the malleable contour is contiguous through the rigid extremity and the sidewall. The rigid extremity and the sidewall can be curved into two planes. A dihedral angle between the first plane and the second plane can range from approximately 180 degrees to approximately 0 degrees, and angles therebetween.

A coupling mechanism can extend through an aperture in the top wall. The coupling mechanism is configured to engage and disengage based on an applied tension. The coupling mechanism can include a receiving member and an inserting member. The receiving member can extend through the aperture in the top wall and be affixed to the top wall. The inserting member is attachable to the receiving member and affixed to a cable. The receiving member includes one or more protruding elements in an opening of the receiving member. The inserting member includes one or more hook elements configured to clasp the protruding elements if the hook elements and protruding elements are in alignment. An upper slanted portion of the hook element causes the hook elements and protruding elements to be out of alignment if the inserting member enters the receiving member a distance greater than a threshold distance.

### BRIEF DESCRIPTION OF THE DRAWINGS

FIG. 1 illustrates a container configured for drone delivery, according to an embodiment.

FIG. 2 illustrates the container in an unfolded form, according to an embodiment.

FIGS. 3A-3E illustrate a process of folding the container, according to an embodiment.

FIGS. 4A-4B illustrate a mechanism for securing a wall of the container, according to an embodiment.

FIG. 5 illustrates internal packaging components within the container in a first arrangement, according to an embodiment.

FIG. 6 illustrates a plurality of products receivable by the container, according to an embodiment.

FIG. 7 illustrates the container having the plurality of products therein, according to an embodiment.

FIG. 8 illustrates internal packaging components within the container in a second arrangement, according to an embodiment.

FIGS. 9A-9B illustrate a process for closing a wall, according to an embodiment.

FIGS. 10A-10B illustrate a mechanism for securing the wall, according to an embodiment.

FIGS. 11A-11B illustrate a coupling mechanism 140 having a receiving member on a top wall of the container, according to an embodiment.

FIG. 12 illustrates the container attached to a suspension device, according to an embodiment.

FIGS. 13A-13C illustrate a container configured for drone delivery, according to an embodiment.

FIGS. 14A-14B illustrate a container configured for drone delivery, according to an embodiment.

FIG. 15 illustrates a container configured for drone delivery, according to an embodiment.

FIG. 16A illustrates a coupling mechanism for a container, according to an embodiment.

FIG. 16B illustrates an inserting member for a container, according to an embodiment.

FIG. 16C illustrates a receiving member for the container, according to an embodiment.

FIG. 16D illustrates an inserting member inserted into a receiving member, according to an embodiment.

FIG. 16E illustrates a top down view of an inserting member, according to an embodiment.

FIG. 16F illustrates a side view of an inserting member, according to an embodiment.

FIG. 16G illustrates a side view of an inserting member inserted into a receiving member, according to an embodiment.

FIG. 17A illustrates the drone enroute to deliver the package, consistent with various embodiments.

FIG. 17B illustrates the drone lowering the package, consistent with various embodiments.

FIG. 17C illustrates the drone placing the package on a drop area at a delivery destination, consistent with various embodiments.

FIG. 17D illustrates the drone retracting the retractable suspension device 135 after dropping the package at the delivery destination, consistent with various embodiments.

FIG. 17E illustrates the hood being fully retracted into a container housing of the drone, consistent with various embodiments.

FIG. 18 is a block diagram illustrating a system to deliver a package using a drone, consistent with various embodiments.

FIG. 19 is a flow diagram of a process for managing the coupling mechanism 140, according to an embodiment.

FIG. 20 is a diagrammatic representation of a machine in the example form of a computer system within which a set of instructions, for causing the machine to perform any one or more of the methodologies or modules discussed herein, can be executed.

The figures depict various embodiments of this disclosure for purposes of illustration only. One skilled in the art can readily recognize from the following discussion that alternative embodiments of the structures and methods illustrated herein can be employed without departing from the principles of the invention described herein.

### DETAILED DESCRIPTION

Certain aspects of the technology disclosed involve a packaging container for drone delivery. The packaging container can include a plurality of rigid extremities disposed to elevate the container above a surface. The rigid extremities can be an extension of one or more walls of the container. Any of the rigid extremities can include an approximately 90 degree bend such that the rigid extremity extends from a first wall on a first plane to a second wall on a second plane where the first plane is at an approximately 90 degree angle relative to the second plane. The plurality of rigid extremities can be positioned on a surface (e.g., on the ground) to elevate a bottom portion of the container casing above the surface.

A wall of the container can be outwardly extendable to create an opening for receiving goods in the container. The container can include one or more configurable stacking elements to position the goods within the container. The container can include a receiving member for receiving the detachable tether. One end of the detachable tether can be affixed to a drone.

The container can include a hydrophobic coating on an outer surface of the container (e.g., one or more walls, a rigid extremity, etc.). The container can include an thermal insulation layer disposed along a surface of one or more walls. The container can include a faraday cage to shield an internal portion of the container from electromagnetic fields. In an embodiment, any combination of the hydrophobic coating, thermal insulation layer, and faraday cage can be incorporated into a single multifunction layer.

The container can be frangible to absorb impact in the event of drone failure. Collapse of the container and/or deformation/fracture of one or more container components can reduce a force of an impact. Reducing a force of impact can increase safety of aerial travel.

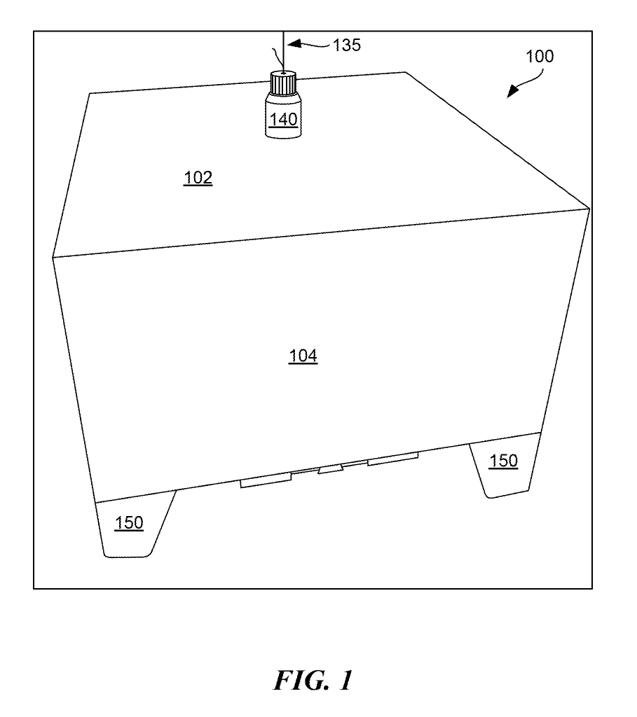

FIG. 1 illustrates a container 100 configured for drone delivery, according to an embodiment. The container 100 can be attached to a retractable suspension device 135 (e.g., a cable) via a coupling mechanism 140 160. The retractable suspension device 135 can be made of any suitable material, e.g., a metal (e.g., titanium, copper, lead, nickel, etc.), a metal alloy (e.g., steel, monel, etc.), microfilament, fluorocarbon, nylon, polyvinylidene fluoride (PVDF, also called fluorocarbon), polyethylene, Dacron and Dyneema (UHMWPE), or any combination thereof. In some embodiments, the retractable suspension device 135 is made of microfilaments in a braided line. In some embodiments, the retractable suspension device 135 is made of a monofilament. The retractable suspension device 135 can include a monofilament core wrapped in a sheath and/or surrounded by a braided layer. In some embodiments, the retractable suspension device 135 is made of a material that can be severed by the application of heat, e.g., within a specified duration.

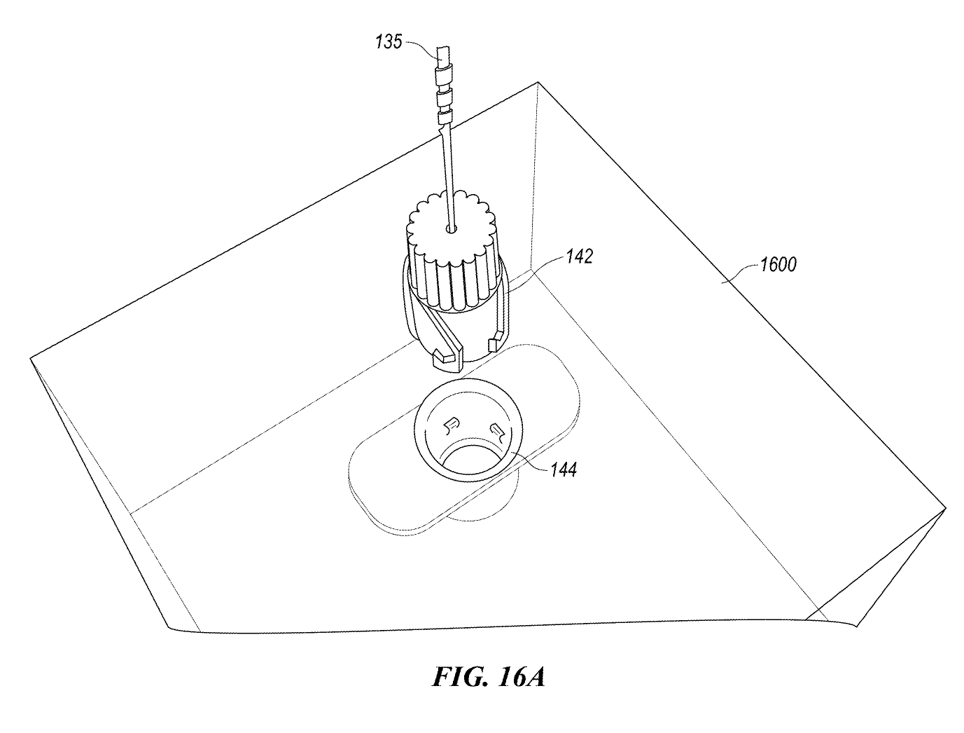

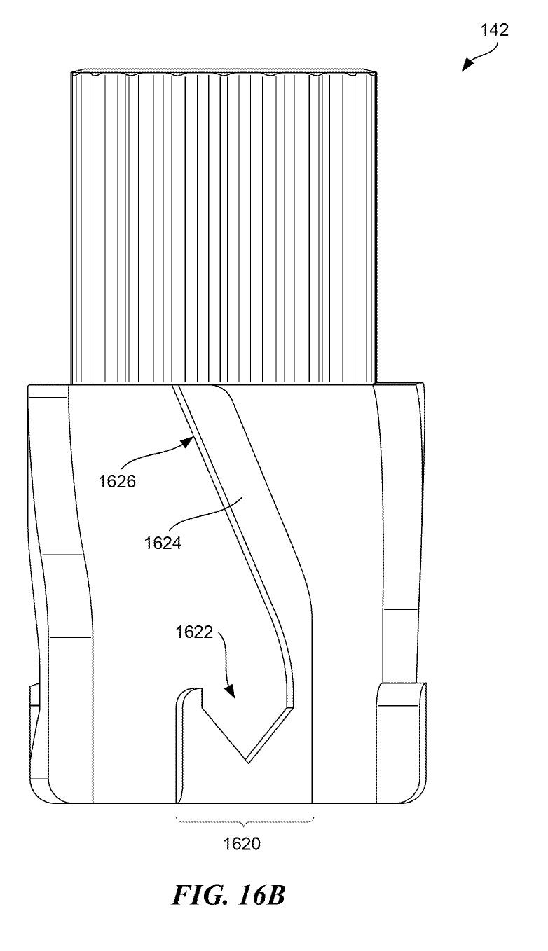

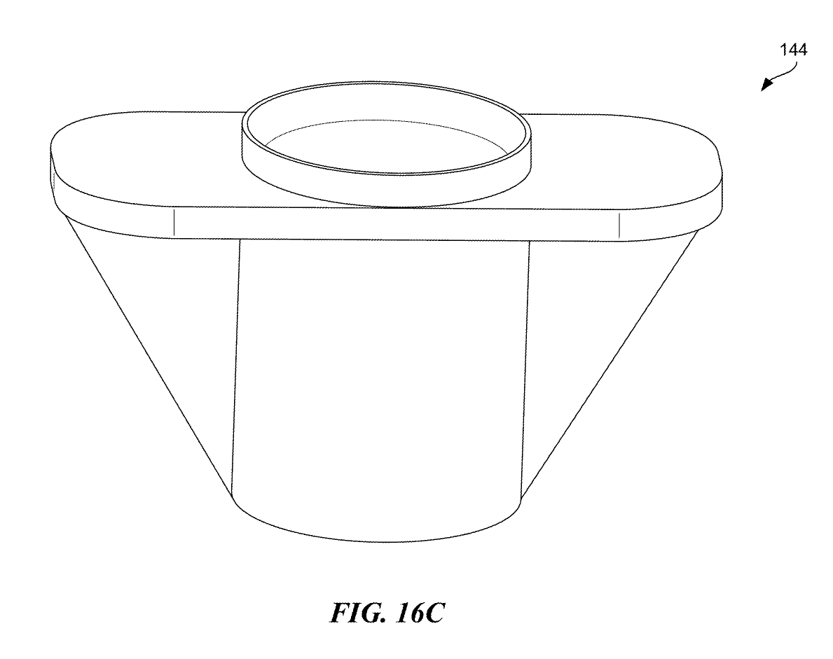

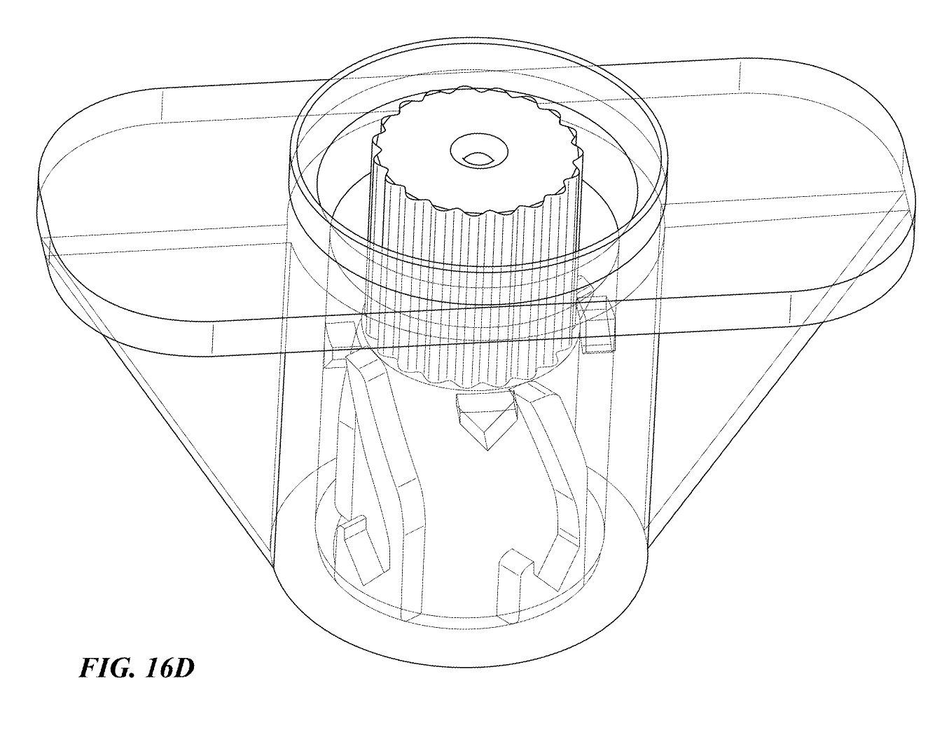

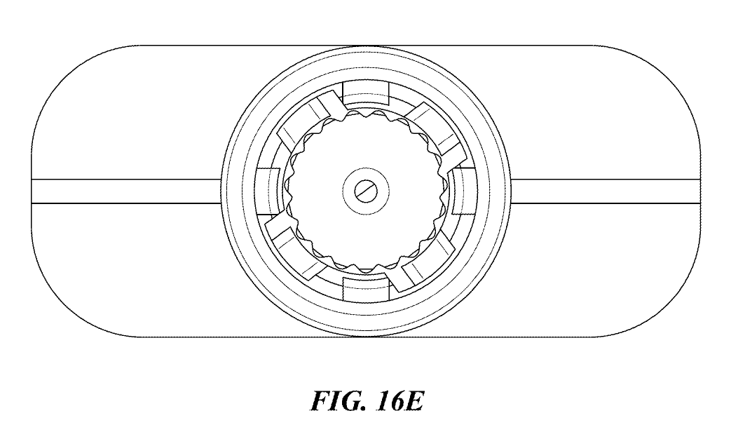

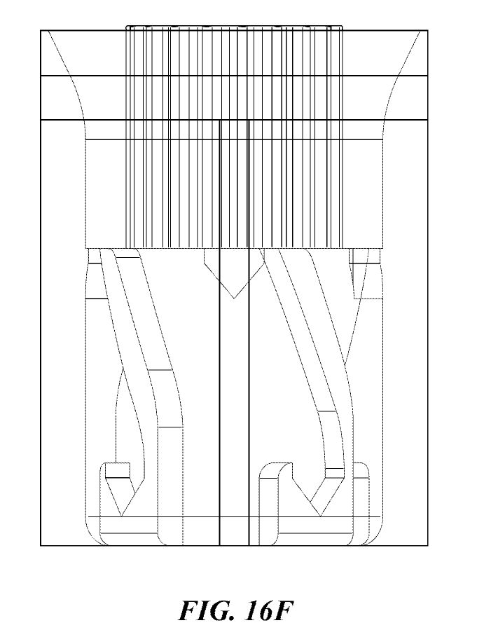

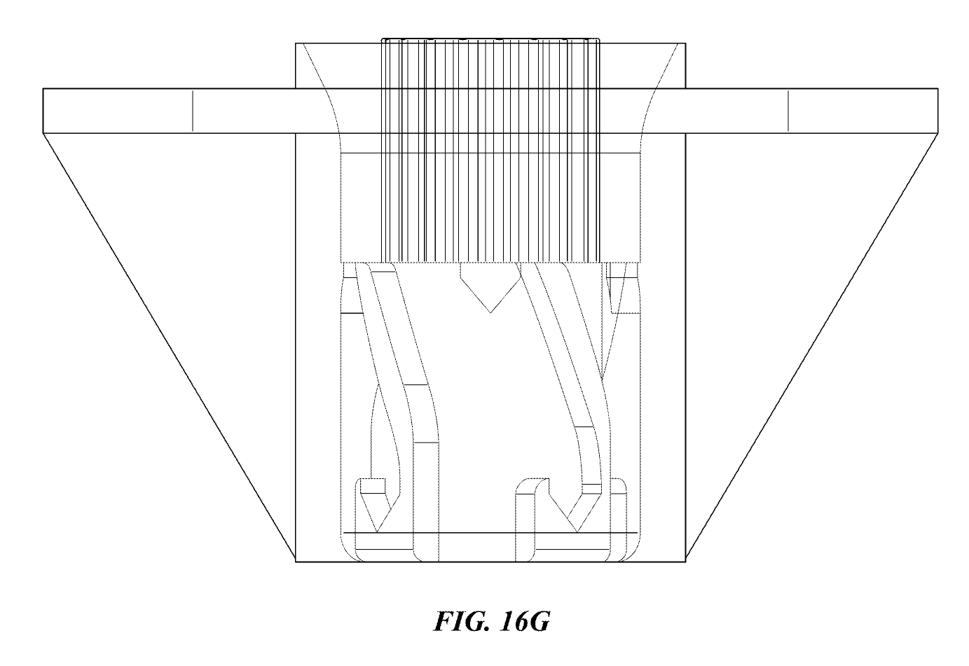

One end of the retractable suspension device 135 is attached to a drone (e.g., an unmanned aerial vehicle), and another end to a coupling mechanism 140 to which the container can be attached. In some embodiments, the retractable suspension device 135 is wound like a coil onto a spindle in the drone though other configurations are possible. The package is attached to the coupling mechanism 140, which locks the package to the retractable suspension device 135. The coupling mechanism 140 can include a tension-dependent locking device, a latch, a clasping device (e.g., a humanoid hand), a magnetic locking device, or any combination thereof. The clasping device can open and close to cause the container to couple and decouple from a cable. The magnetic locking device can include an electromagnetic coil composed of a conductive material configured to receive an electric current to generate a magnetic field. The generated magnetic field can cause the container to couple with the cable and termination of the magnetic field (e.g., by terminating the current) can cause the container to decouple from the cable. The coupling mechanism 140 can be configured to switch to an engaged position upon application of a tension in the retractable suspension device 135. A drone connected to an end of the retractable suspension device 135 can apply a tension to the retractable suspension device 135 to engage the coupling mechanism 140. If the drone releases a tension on the retractable suspension device 135, the coupling mechanism 140 disengages. The coupling mechanism 140 is described further below with reference to FIGS. 16A-16G.

### Rigid Extremities

The packaging container can include a plurality of rigid extremities 150 disposed to elevate the container above a surface. For example, a rectangular container can include four rigid extremities 150 extending downward on each corner. The rigid extremities 150 can be an extension of one or more walls of the container. For example, a first rigid extremity and a second rigid extremity can be a continuation of a single wall. A malleable contour extending a vertical length of the wall can bend approximately 90 degrees so the first wall extends around a corner of the container. The first and second extremities (e.g., extensions of the wall) can coexist at the corner of the container such that the rigid extremities 150 extend from a first plane to another plane where the first plane is at an approximately 90 degree angle relative to the second plane. The approximately 90 degree bend in the first and second extremities extending from a single wall can provide significantly more strength than a rigid extremity extending along a single plane.

The plurality of rigid extremities 150 can be positioned on a surface (e.g., on the ground) to elevate a bottom portion of the container casing above the surface. A vertical length of the rigid extremities 150 can range from approximately 0.5 cm to approximately 15 cm, and ranges therebetween. For example, the vertical length of the rigid extremities 150 can range from approximately 0.5 cm to 1.5 cm, 1.0 cm to 2.0 cm, 2.5 cm to 3.5 cm, 3.0 cm to 4.0 cm, 3.5 cm to 4.5 cm, 4.0 cm to 5.0 cm, 4.5 cm to 5.5 cm, 5.0 cm to 6.0 cm, 5.5 cm to 6.5 cm, 6.0 cm to 7.0 cm, 6.5 cm to 7.5 cm, 7.0 cm to 8.0 cm, 7.5 cm to 8.5 cm, 8.0 cm to 9.0 cm, 8.5 cm to 9.5 cm, 9.0 cm to 10.0 cm, 9.5 cm to 10.5 cm, 10.0 cm to 11.0 cm, 10.5 cm to 11.5 cm, 12.0 cm to 13.0 cm, 12.5 cm to 13.5 cm, 13.0 cm to 14.0 cm, 13.5 cm to 14.5 cm, 14.0 cm to 15.0 cm, or any combination of ranges therein. In an embodiment, each of the plurality of rigid extremities 150 have approximately the same vertical length. In another embodiment, on or more of the plurality of rigid extremities 150 can have a vertical length varying from other rigid extremities 150. For example, two of four rigid extremities 150 may vary in length to allow the container to be positioned relatively horizontally on a slope or stairs.

### Wall Opening

A wall of the container can be outwardly extendable to create an opening for receiving goods in the container. A contour extending along an edge (e.g., a bottom edge) of the wall can be malleable enabling the wall to be rotationally displaced along the contour. Rotationally displacing the wall along the contour can result in opening and closing the wall of the container. One or more fastener elements of the wall can engage with complementary fastener elements of one or more other walls of the container.

### Stacking Elements

The container can include one or more configurable stacking elements to position goods within the container. Walls of the container include a first set of one or more divots to receive the stacking elements in a first position and a second set of one or more divots to receive the stacking elements in a second position.

### Hydrophobic Coating

The container can include a hydrophobic coating on an outer surface of the container (e.g., one or more walls, a rigid extremity, etc.). The hydrophobic coating can be composed of, for example, a nonpolar chemical substance (e.g., an alkane). The hydrophobic coating can repel polar liquids (e.g., water) from the outer surface of the container. Repelling polar liquids from the outer surface of the container can help to maintain structural integrity of the container.

### Thermal Insulation Layer

The container can include an thermal insulation layer. The thermal insulation layer can be disposed along a surface of one or more walls. The thermal insulation layer can maintain a temperature of goods within the container. The thermal insulation layer can reduce thermal conduction and/or reflect thermal radiation. The thermal insulation layer can be composed of a material having low thermal conductivity and/or a high thermal reflectivity.

In an embodiment, a multifunction layer incorporate a hydrophobic coating and a thermal insulation layer. For example, the multifunction layer can be formed by mixing a thermosetting resin (e.g., polyurethane) with a blowing agent (e.g., sodium bicarbonate) and applying a resulting foam product to an outer surface of one or more walls. In another example, a cured liquid silicone emulsion can be integrated into a substrate (polystyrene foam, urethane foam, vermiculite, perlite, etc.) during processing to create a substrate integrated with the cured liquid silicone emulsion. The substrate integrated with the cured liquid silicone emulsion can be applied to an outer surface of one or more walls.

### Faraday Cage

The container can include a faraday cage. The faraday cage includes a mesh of one or more conductive materials. The faraday cage can enclose an entire internal portion of the container or any portion thereof. For example, the faraday cage can enclose a lower half of the container. The faraday cage can protect an electronic device from electromagnetic fields (e.g., lightning).

In an embodiment, a multifunction layer can incorporate any combination of a faraday cage, thermal insulation layer, and hydrophobic coating. For example, the multifunction layer can be composed of a conductive metal foam. The conductive metal foam can be formed by mixing a metal (e.g., copper, aluminum, zinc, nickel, brass, bronze, iron, silver, gold, or any combination thereof) with a blowing agent (e.g., powdered titanium hydride and/or zirconium hydride) at elevated temperatures. The mixture of the metal and blowing agent can react and release a gas (e.g., hydrogen gas) resulting in a patchwork of gas filled pockets throughout the mixture. The resulting low-density metal foam can be conductive, thermally insulating, and water-proof (assuming no gas filled pockets extend through the material).

### Frangibility

The container can be frangible to absorb impact in the event of drone failure. Walls and/or rigid extremities 150 of the container can deform and/or fracture upon impact. A fastener element securing a wall to another wall can fail upon an impact exceeding a threshold. Failure of the fastener element can release any goods within the container and cause the container to collapse. Collapse of the container and/or deformation/fracture of one or more container components can reduce a force of an impact. Reducing a force of impact can increase safety of aerial travel.

In an embodiment, a multifunction layer can incorporate any combination of an impact absorption layer, faraday cage, thermal insulation layer, and hydrophobic coating. Various embodiments involve lining an inner or outer surface of one or more walls with the multifunction layer. The multifunction layer can be composed of, for example, a foam material. The foam material can be conductive, thermally insulating, hydrophobic or water-resistant, or any combination thereof. For example, the multifunction layer can include a conductive and thermally insulating metal foam, a thermally insulating and hydrophobic polymeric foam.

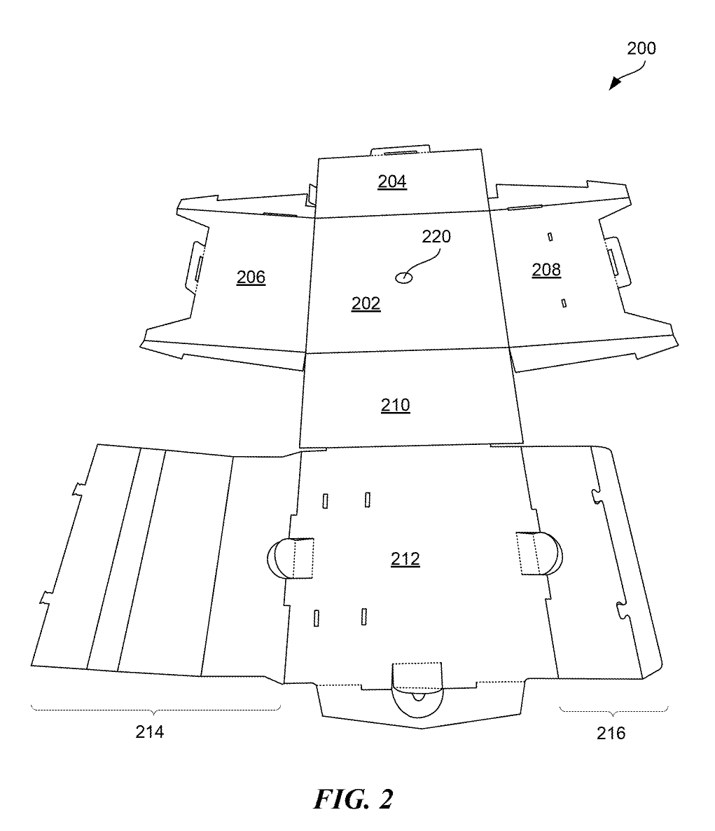

FIG. 2 illustrates the container in an unfolded form, according to an embodiment. The container includes a plurality of malleable contours. The malleable contours can be composed of a malleable material such as, for example, an elastomer (e.g., isoprene, polybutadiene, chloroprene, styrene-butadiene, ethylene propylene, fluoroelastomer, polyether block amides, elastolefin, or any combination thereof) and/or another polymer (e.g., cellulose fiber, hemi-cellulose fiber, and lignin), calcium carbonate, clay, titanium oxide, or any combination thereof. The malleable contours can include a composition corresponding to one or more adjacent walls or a unique composition. The malleable contours can be treated to increase malleability. A treatment can include a chemical and/or physical process to increase malleability such as, for example, exerting a force to cause a bend along a contour line, applying a mildly corrosive agent along a contour line, or a combination thereof. The treatment can weaken intermolecular forces of a material within the malleable contour.

The malleable contours enable walls of the container to move from a first plane to a second plane. The container can include a bottom wall, top wall, four vertical walls, four rigid members (e.g., for elevating the container above a surface), a plurality of securing mechanisms, or any combination thereof. Walls are referred to as “bottom”, “top”, and “vertical” for simplicity. A person of ordinary skill in the art can appreciate that the container can rotate in three dimensional space such that any side can be oriented in any direction.

Two rigid members can be an extension of a single wall (e.g., any sidewall). For example, two rigid members can be an extension of a sidewall 206 and two rigid members can be an extension of a sidewall 208. A rigid member extends approximately 0.5 cm to approximately 15 cm, and ranges therebetween, beyond a length of a vertical wall. The rigid member can include a malleable contour extending into a wall from which the rigid member extends. The rigid member and an outer portion of the wall can bend along the malleable contour such that the rigid member and the wall extend along two distinct planes. A center portion of the wall and a portion of the rigid member can extend along a first plane while an outer portion of the wall and another portion of the rigid member extend along a second plane. A dihedral angle between the first plane and the second plane can range from approximately 180 degrees to approximately 0 degrees, and angles therebetween. In an embodiment, the dihedral angle between the first plane and the second plane is approximately 180 degrees in an unfolded form and approximately 90 degrees in a folded form. An approximately 90 degree angle between the first plane and the second plane extending a length (e.g., a vertical length) of the rigid member can result in additional strength in the rigid member compared to a rigid member having a more obtuse angle (e.g., 120 degrees to 180 degrees) between the first and second planes. The additional strength can, for example, provide the container with sufficient strength to endure an impact from an aerial drop of a threshold height (e.g., ranging from several centimeters to several meters). The threshold height can vary based on material composition of the rigid member, vertical length of the rigid member, weight of the container, and weight of the contents in the container. The rigid member can fail if an aerial drop exceeds the threshold height. By failing (e.g., crumbling), the rigid member can absorb a portion of an impact force, thereby reducing an impact force on any contents in the container. In addition, absorbing a portion of the impact force can reduce an impact on a surface being impacted (e.g., the ground).

A bottom wall 212 can have four sides with each side having a malleable contour dividing the bottom wall from another wall (e.g., one or more sidewalls and/or one or more internal packaging components) and/or a securing mechanism (e.g., an insertable tab, hoop and loop fastener, etc.). For example, malleable contours can divide the bottom wall 212 from a sidewall 210 extending a length of the two opposing sides. Malleable contours can divide two opposing sides of the bottom wall 212 from an insertable tab in a middle portion and internal packaging components (e.g., a configurable compartment 214 and a partial shelf 216) extending a length of the two opposing sides.

Top wall 202 can include an aperture 220. Aperture 220 can be configured to attach to a coupling mechanism or a portion of a coupling mechanism. For example, aperture 220 can be attached to a inserting member (e.g., inserting member 144 of FIG. 16A). Aperture 220 can include reinforcement elements to reduce a likelihood of failure between the coupling mechanism and the container. For example, the aperture 220 can include a supporting member lining an outer edge of the aperture. The supporting member can be composed of a high tensile strength material (e.g., a steel or nylon wire). Additional supporting members (e.g., additional steel or nylon wire) can be affixed to the supporting member lining the outer edge of the aperture and extend to other portions of the container. For example, the additional supporting members can line the top wall 202 or can be integrated into the top wall 202.

Top wall 202 can have four sides with each side having a malleable contour dividing the top wall from another wall (e.g., one or more vertical walls) and/or a securing mechanism (e.g., an insertable tab, hoop and loop fastener, etc.). For example, the top wall 202 can be adjacent to sidewall 204, sidewall 206, sidewall 208, and sidewall 210. A coupling mechanism 140 can be affixed to the top wall. The coupling mechanism 140 can include a receiving member. The receiving member is affixed to a central region of the top wall. A central region of the top wall can be used to affix the receiving member so that the container is approximately balanced if suspended by a cable connected to the receiving member. The coupling mechanism 140 is described further below with reference to FIGS. 16A-16G.

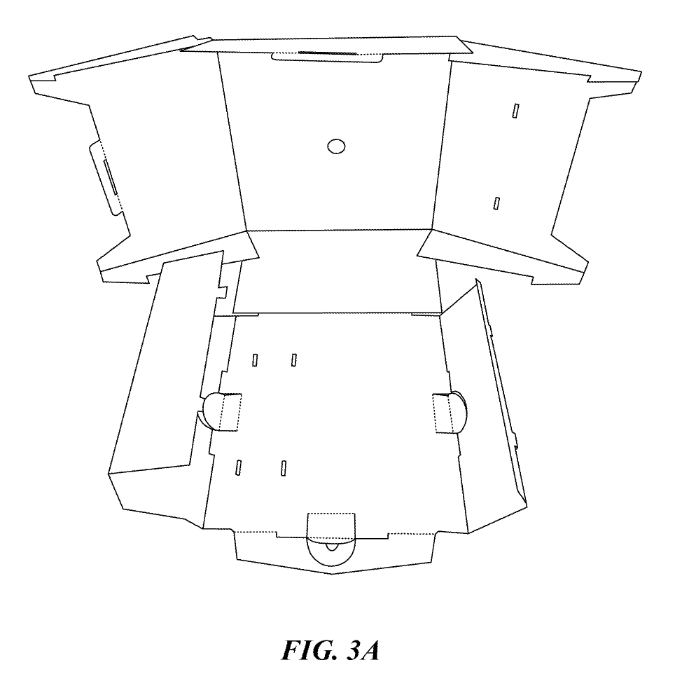

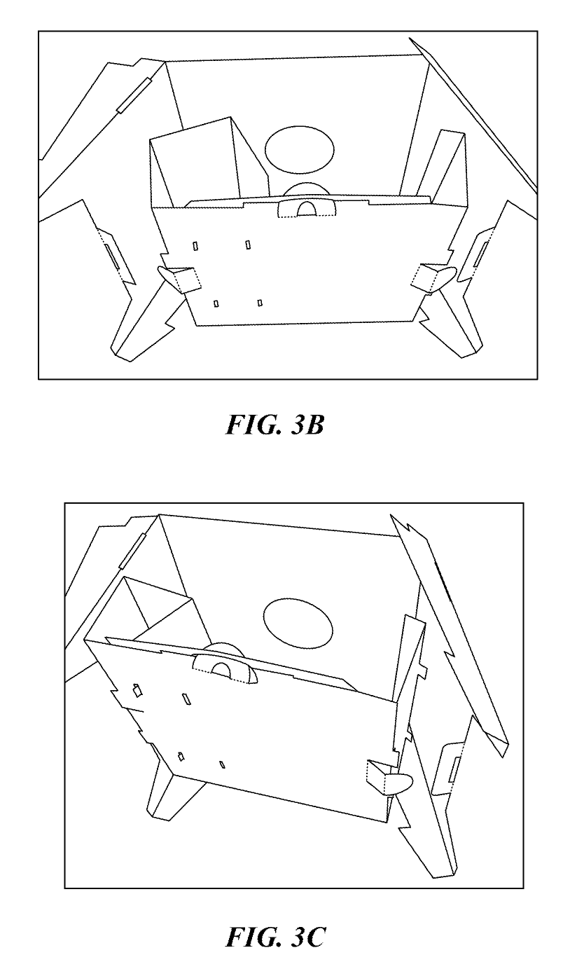

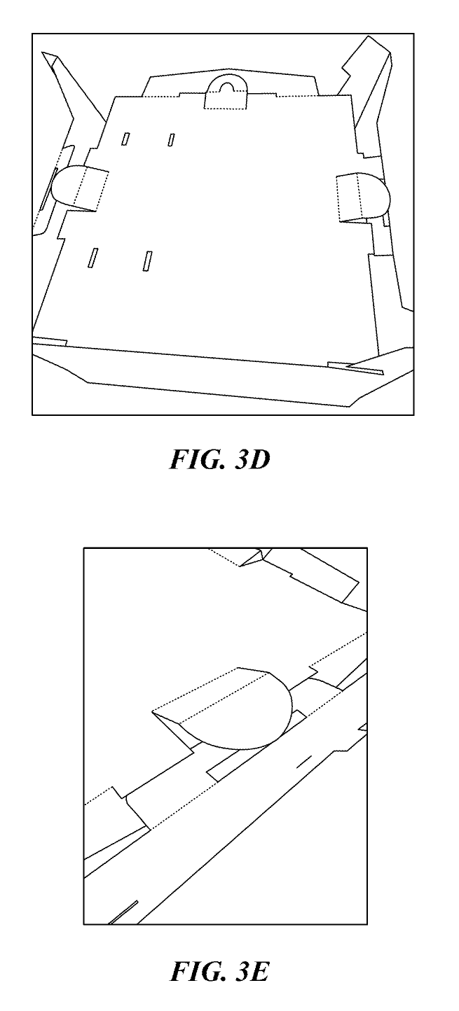

FIGS. 3A-3E illustrate a process of folding the container along the plurality of malleable contours, according to an embodiment. In FIG. 3A, a vertical wall adjacent to the bottom wall is bent upward. Internal packaging components adjacent to the bottom wall are bent upward. Vertical walls adjacent to the top wall each include two approximately 90 degree bends extending a length of the vertical walls and extending into two rigid extremities 150. FIGS. 3B-3E illustrate the vertical walls adjacent to the top wall being positioned within range of a securing mechanism of the bottom wall.

FIG. 3B shows internal packing components arranged in a first orientation. The internal packaging components can be inserted into a pair of pre-cut slits in the bottom wall. FIG. 3C shows internal packaging components arranged in a second orientation. The internal packing components can be inserted into another pair of pre-cut slits in the bottom wall. The first orientation or second orientation can be used to accommodate products of varying dimensions within the container. Although only the first orientation and second orientation are shown, various alternative and supplemental orientations are contemplated. For example, alternative and/or additional orientations can be incorporated by including pre-cut slits in, for example, other portions of the bottom wall, the vertical wall, the top wall, or any combination thereof.

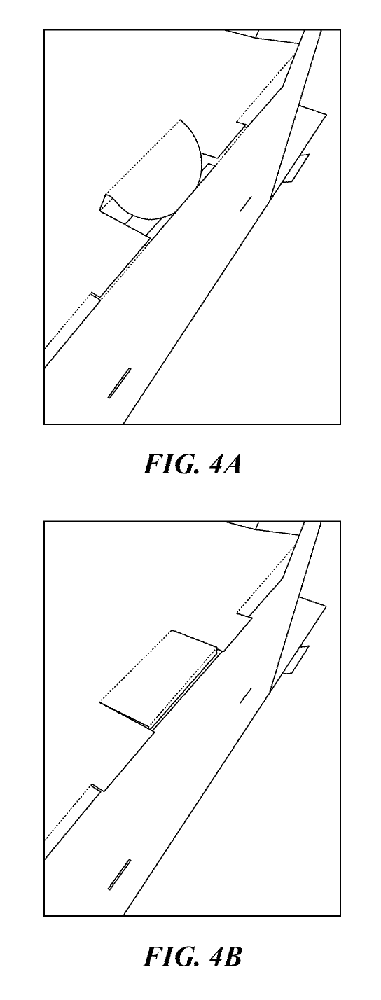

FIGS. 4A-4B illustrate a mechanism for securing a wall of the container, according to an embodiment. The two vertical walls adjacent to the top wall are secured to the bottom wall via the securing mechanism. Although a tab insert is illustrated in FIGS. 4A-4B, a person of ordinary skill in the art would appreciate that alternative or supplemental securing mechanisms are contemplated. For example, the securing mechanism can include a tab insert, a hook and loop fastener, an adhesive, or any combination thereof.

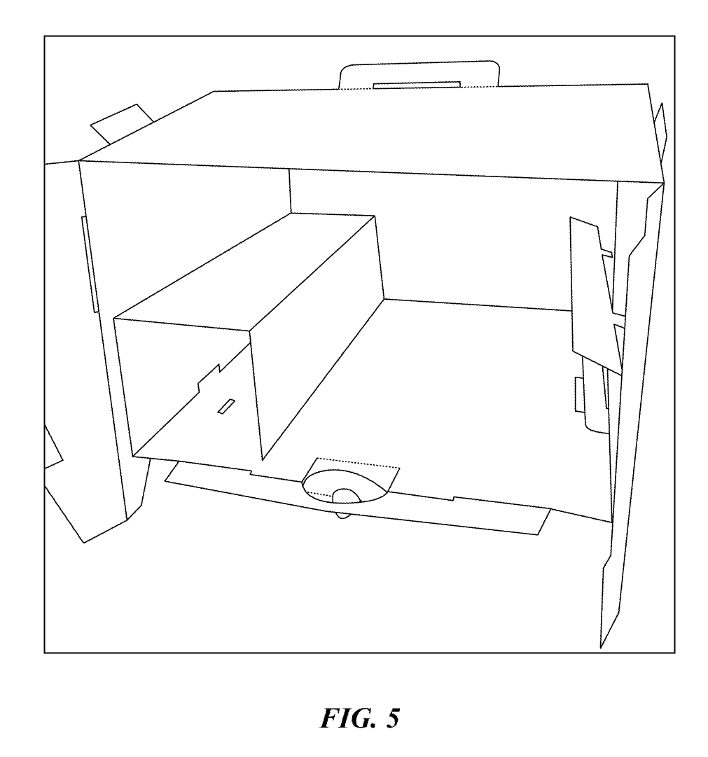

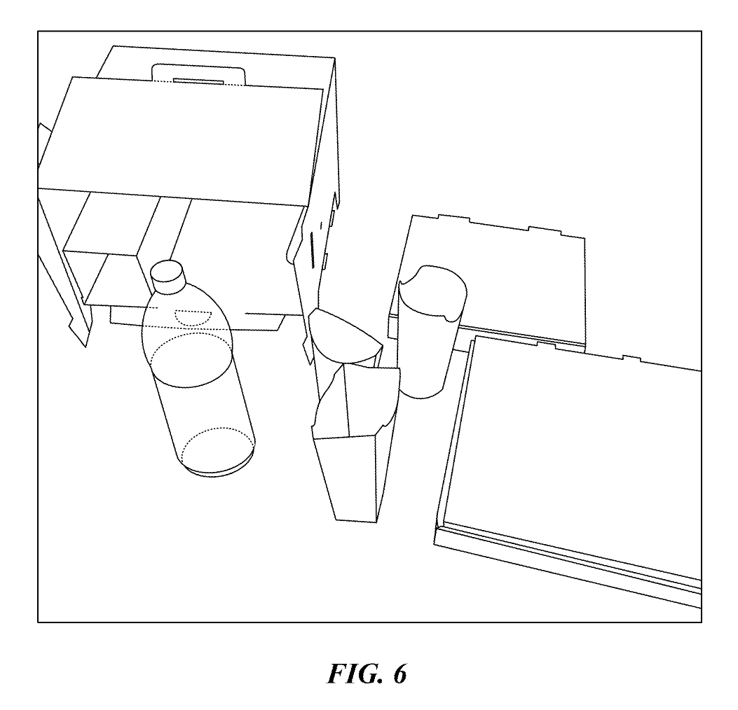

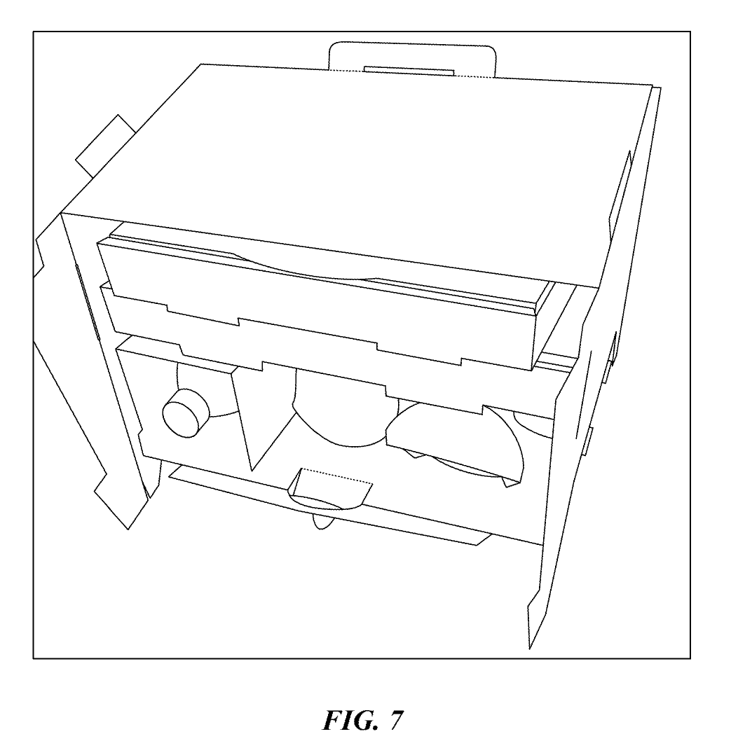

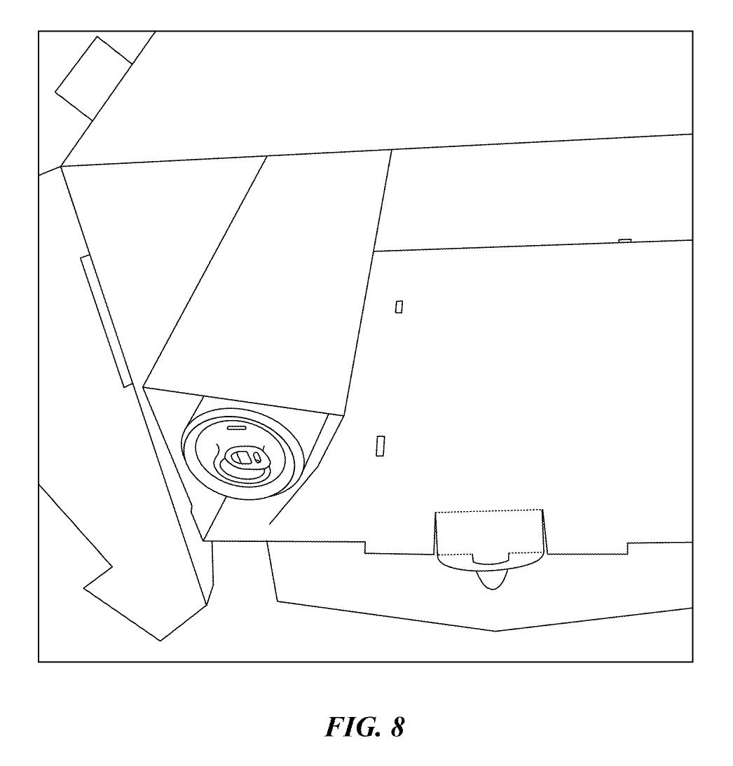

FIG. 5 illustrates internal packaging components within the container in a first arrangement, according to an embodiment. The internal packaging components can be configured in the first arrangement. The first arrangement includes the internal packaging components inserted into a pair of pre-cut slits in the bottom wall. The internal packaging components in the first arrangement can accommodate a set of products. For example, the first arrangement can accommodate the products shown in FIG. 6. FIG. 6 illustrates a plurality of products receivable by the container. The products can include, for example, one or more pizza boxes (e.g, two large pizzas), a beverage bottle (e.g., a 2 liter bottle or 8 oz bottle), packaged salad, packaged pasta, stuffed cheesy bread, bread sticks, an oven baked sandwich, chicken wings, boneless chicken, one or more desserts (e.g., brownies, milkshake, etc.), one or more sauce packets, or any combination thereof.

FIG. 7 illustrates the container having the plurality of products therein. FIG. 7 shows a 2 liter bottle inserted in an opening framed by internal packaging components. The opening has dimensions of approximately 10 cm by approximately 10 cm. On an opposite side as the opening within the container is a partial shelf extending from a vertical wall of the container. The partial shelf can be positioned in line with an upper surface of the opening. For example, if an opening has a height of approximately 10.2 cm from a lower surface of the inside of the container, the partial shelf can extend from a vertical wall at approximately 10.2 cm from the lower surface of the inside of the container. A 2 liter bottle can have a diameter of slightly less than 10.2 cm. A 2 liter bottle can snuggly fit within the opening. A 2 liter bottle within the opening can be substantially secured in place.

The upper surface of the opening and the upper surface of the partial shelf can be substantially horizontal. A space above the upper surface of the opening and the upper surface of the partial shelf is referred to as an “upper storage region.” The upper storage region can be used to store one or more boxes. For example, one or more boxes can be stacked on top of the upper surface of the opening and the upper surface of the partial shelf. As shown in FIG. 7, one or more pizza boxes (e.g., a large pizza box and a medium pizza box) can be stacked on the upper surface of the opening and the upper surface of the partial shelf. Products stored in the upper storage region may exceed a threshold diameter to avoid falling into a lower storage region. For example, products stored in the upper storage region may exceed a diameter ranging from approximately 10 cm to approximately 35 cm, and ranges therebetween. Ranges therebetween include, for example, 18 cm to 20 cm, 20 cm to 22 cm, 22 cm to 24 cm, 24 cm to 26 cm, etc.

Below the partial shelf and adjacent to the opening is a space referred to as a “lower storage region.” In the first arrangement, the second storage region can have a width of approximately 25 cm and a length of approximately 35 cm. One or more additional products can be secured. For example, salad, pasta, breadsticks, or any combination thereof can be stored in the lower storage region. Storage in the lower storage region can accommodate a varied array of products without a lower diameter limit.

FIG. 8 illustrates internal packaging components within the container in a second arrangement, according to an embodiment. The internal packing components can be inserted into a pair of pre-cut slits in the bottom wall differing from the pair of pre-cut slits used for the first arrangement. The first arrangement and/or second arrangement can be used to accommodate products of varying dimensions within the container. For example, the first arrangement can be used to secure a large beverage (e.g., a 2 liter bottle) in the opening whereas the second arrangement can be used to secure a small beverage in the opening (e.g., an 8 oz. bottle and/or a soda can).

The upper surface of the opening can be substantially in alignment with the partial shelf in the second arrangement. Thus, storage size of the opening can be altered while substantially maintaining dimensions of the upper storage region. For example, one or more pizza boxes (e.g., two large pizza boxes) can be stacked on the upper surface of the opening and the upper surface of the partial shelf in the second arrangement. Space in the lower storage region may be larger in the second arrangement than in the first arrangement. For example, a lower portion of the lower storage region can have a width of approximately 30 cm and a length of approximately 35 cm. In an example, an upper portion of the lower region can have a width of approximately 25 cm and a width of approximately 35 cm.

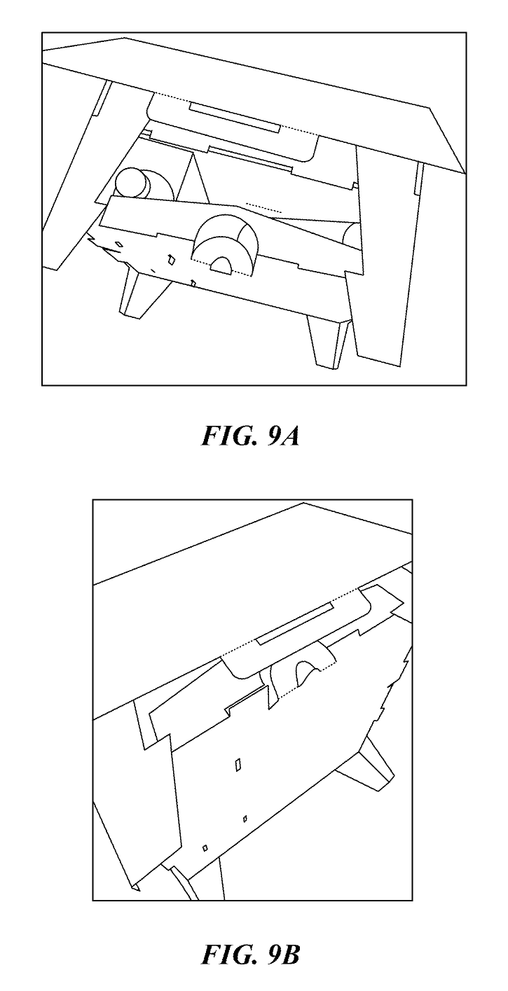

FIGS. 9A-9B illustrate a process for closing a wall, according to an embodiment. A contour extending along an edge of the wall can be malleable enabling the wall to be rotationally displaced along the contour. Rotationally displacing the wall along the contour can result in opening and closing the wall of the container. The malleable contour can extend along an upper edge of the wall so the wall can be rotationally displaced upward to open and rotationally displaced downward to close.

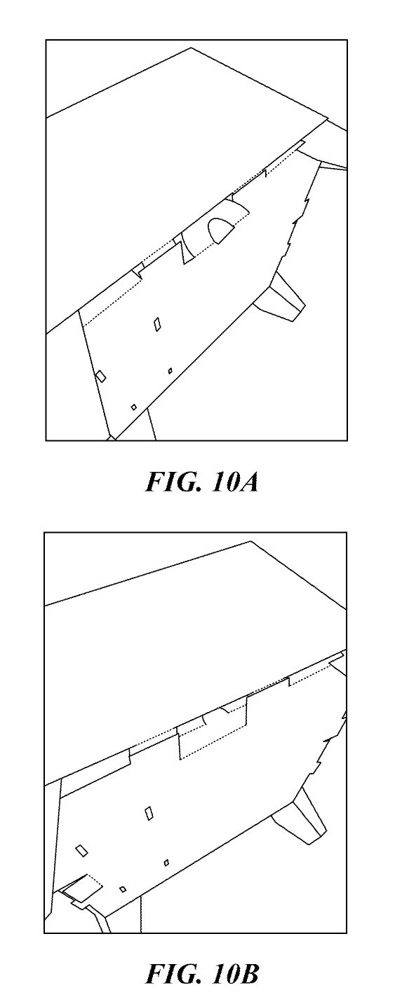

As shown in FIG. 9B, a first tab extending along another edge of the wall (e.g., a sidewall) can include a first slit therein. A second tab extending along an edge of another wall (e.g., a bottom wall) can have a width approximately corresponding to a width of the first slit in the first tab. The first tab can be inserted into a second slit in the another wall (e.g., bottom wall or top wall) of the container. The first tab can be inserted into the second slit, and a second tab can be inserted into the first slit. Dual tabs (e.g., the first tab and the second tab) can securely fasten the the wall (e.g., a sidewall) to another wall (e.g., a bottom wall). FIGS. 10A-10B illustrate the second tab being inserted into the first slit within the first tab.

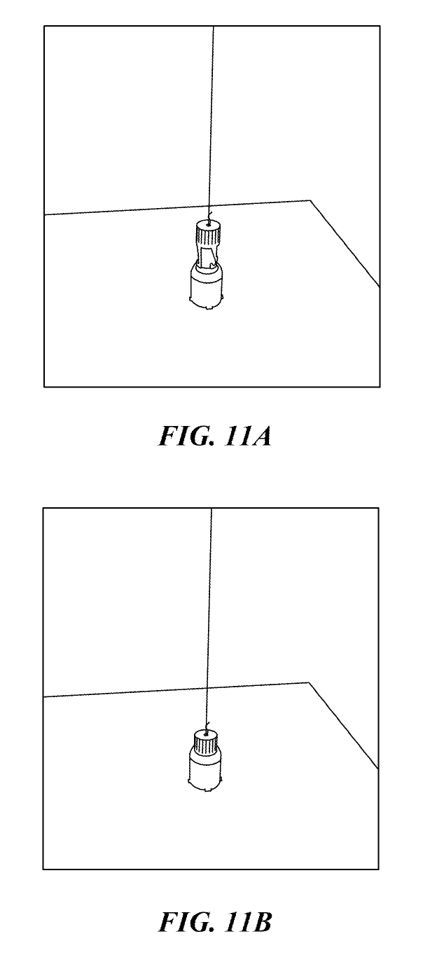

FIGS. 11A-11B illustrate a coupling mechanism 140 on a top wall of the container, according to an embodiment. The container can include a coupling mechanism 140 to lock and unlock a package attached to the UAV based on the weight of the package. When the package is attached to retractable suspension device 135 of the UAV that lowers the package to the ground from the UAV, the coupling mechanism 140 automatically switches to an engaged position, due to the weight of the package, to lock the package to the retractable suspension device 135. When the package is lowered and dropped on the ground, the weight of the package is offloaded from the retractable suspension device 135, which causes the coupling mechanism 140 to automatically switch to a disengaged position, thereby releasing the package.

The coupling mechanism 140 can include a receiving member and an inserting member. The receiving member can be affixed to a wall (e.g., a top wall) of the container. A fastening mechanism (e.g., a threaded fastener) can affix the receiving member to a wall. The receiving member can extend through an opening in the wall. An inner portion of the receiving member can have a width greater than the opening of the wall. By having an inner width larger than an opening in the wall, a force pulling the receiving member outward cannot remove the receiving member without causing the wall and/or member to fail (e.g., fracture or deform).

The receiving member includes an opening configured to receive the inserting member. A surface of the opening of the receiving member includes a plurality of protruding elements. The protruding elements can be linked to hook elements of the inserting member if the hook elements are caused to be in a position in line with the protruding elements. A slanted extension of the hook elements positions the hook elements out of alignment with the protruding elements if the hook element enters deeply within the opening of the receiving member (e.g., due to slack in a cable affixed to the inserting member). Further illustration and description of the coupling mechanism 140 is provided below with reference to FIGS. 16A-16G.

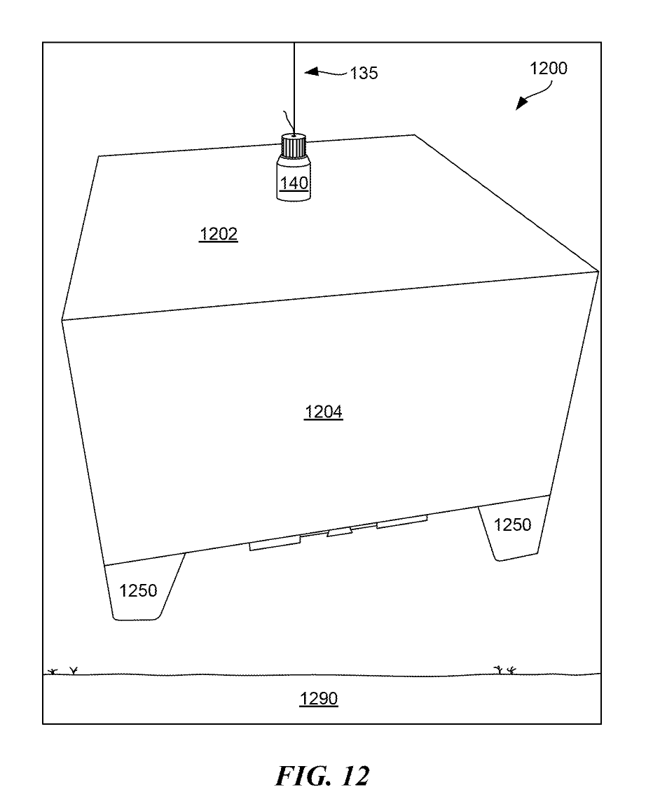

FIG. 12 illustrates a container 1200 suspended above ground 1290 by a retractable suspension device 135, according to an embodiment. The container 1200 can include one or more rigid extremities 1250. Any of the one or more rigid extremities 1250 can be an extension of a wall (e.g., an extension of a sidewall). The one or more rigid extremities 1250 can include a bend (e.g., a 90 degree bend). The bend can increase the strength of the one or more rigid extremities. An increased strength can enable a greater height (e.g., several inches to a foot) of the rigid extremities and/or heavy contents in the container (e.g., liquid products) without failure of the extremities. The rigid extremities can fail from an impact of a threshold force to reduce an impact intensity from, for example, the container falling to the ground (e.g., due to a drone failure).

The container 1200 can include one or more stacking elements for positioning and temporarily storing a product during an aerial delivery. The container 1200 can include one or more protective layers including, for example, a hydrophobic coating, thermal insulation layer, a faraday cage, or any combination thereof. The one or more protective layers can protect the structural integrity of the container and/or one or more products stored in the container during an aerial delivery.

The container 1200 includes various compartments for carrying various types of products including, for example, food products (e.g., hot, cold, solid, and/or liquid food products), electronics (e.g., mobile telephone, tablet, laptop computer, etc.), office supplies (e.g., paper, ink, pens, pencils, staplers, etc.), emergency supplies (e.g., medicine, bandages, oxygen mask, and other first aid), and any combination thereof. Products types and/or combinations can influence container configurations. For example, a container for aerial transportation of electronic products can include a faraday cage to shield electronic products from electromagnetic pulses (e.g., lightning, solar flares, etc.). In an example, a container for aerial transportation of warm food can include one or more insulation layers to maintain a food temperature during transportation. In an example, a container for aerial transportation of a mixture of hot food products and cold food products can include insulated stacking elements to reduce heat transfer between hot and cold food products. For instance, the container 1200 can have separate sections for different types of food. The container 1200 includes a hot food compartment and a cold food compartment. the hot food and cold food compartments can be separated by a wall, which can have an insulated material. The container 1200 includes ventilation to keep hot food such as chips crisp.

The container 1200 can be connected to the retractable suspension device 135 of the drone at a coupler. The coupler can be off center toward a compartment that carries heavier products, e.g., drinks, to ensure the weight is centered when heavier items are included. A sliding mechanism (not shown) can allow the coupling mechanism 140 to be repositioned. The coupling mechanism 140 can be repositioned according to a center of gravity of the container. For instance, if heavy products are included on a first side of the container and lighter products are included on a second side of the container, the center of gravity of the container may be shifted to the first side. The sliding mechanism (e.g., a track extending in a linear direction along a center portion of the container) can allow the coupling mechanism to be repositioned toward the first side of the container where the center of gravity has shifted. By allowing the coupling mechanism to be repositioned toward the center of gravity, the container can be suspended from the retractable suspension device 135 in a relatively level orientation.

The container 1200 can be made of a polymer, paper product (e.g., paperboard, cardboard, etc.), metal (e.g., aluminum or tin), or any combination thereof. The container 1200 can have one or more lids which, when opened, provide access to the contents inside. In some embodiments, the lids open away from each other so that any area/compartment in the container 1200 can be accessed conveniently.

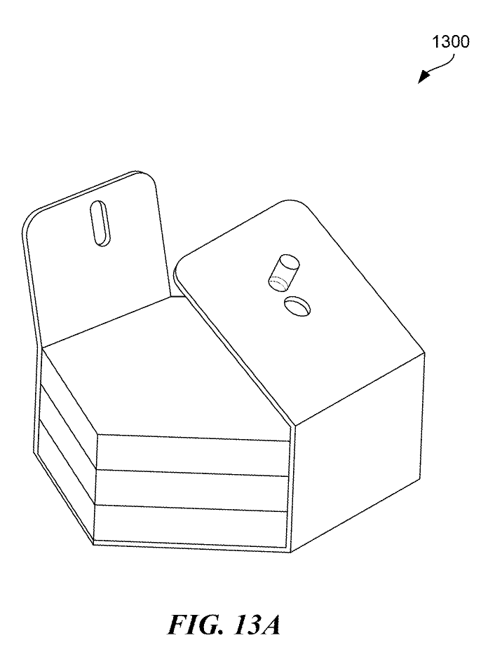

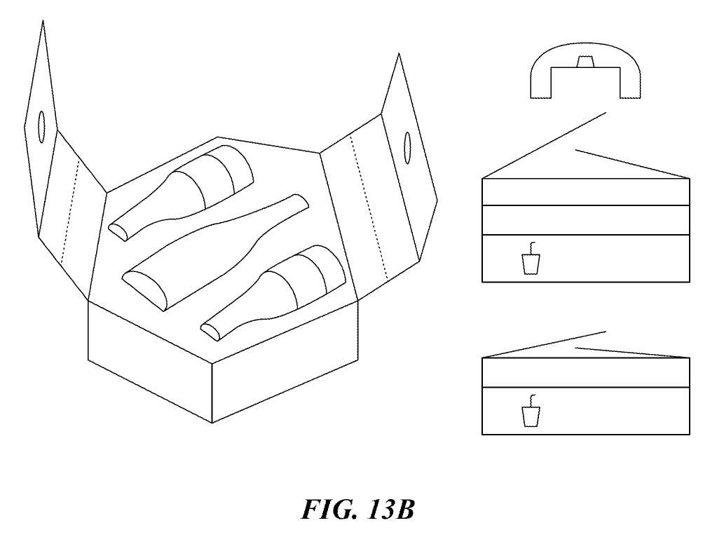

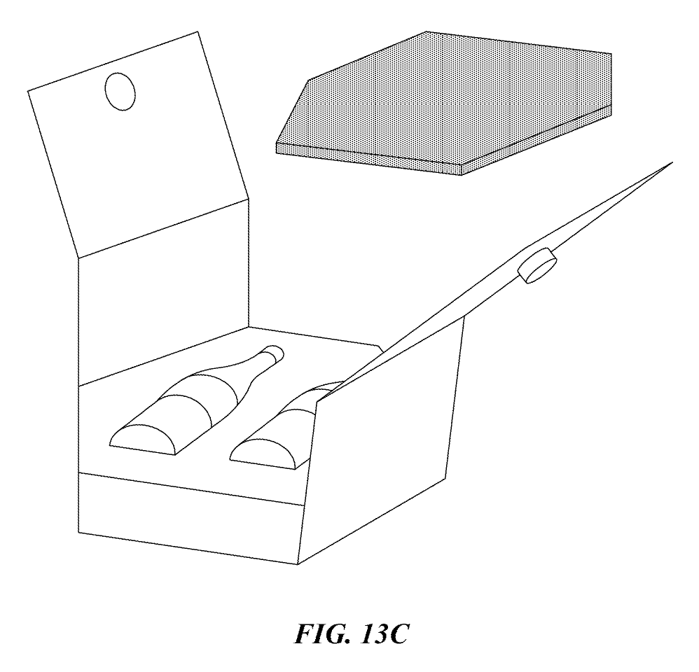

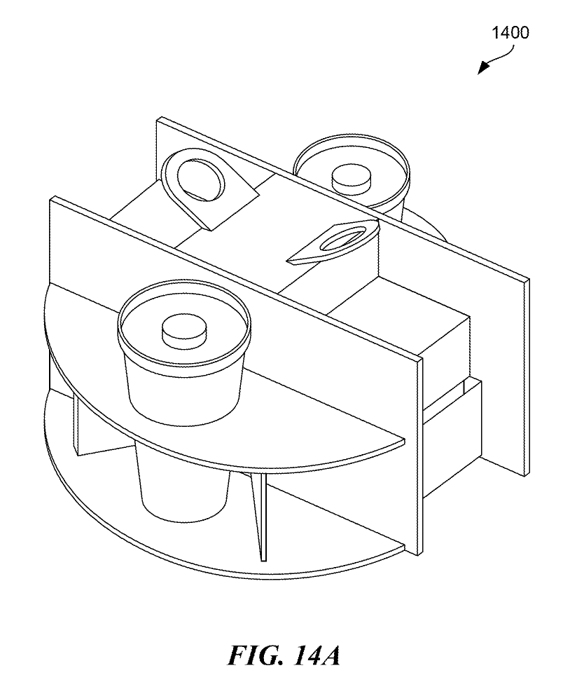

FIGS. 13A-13C illustrate a container configured for drone delivery, according to an embodiment. FIG. 13A is a block diagram of an hex-box container for delivering food, consistent with various embodiments. The container can be used to carry food and drinks such as a pizza and a beverage, e.g., soda or wine. The container is an adjustable hex box, which has three compartments stacked one over the other. The top two of the three compartments can be used to carry pizza, and the bottom compartment can be used to carry drinks. The container can be made of paper, cardboard or a similar suitable material and can be assembled easily from an initial flat sheet, e.g., by folding the sheet along the fold lines. The container can be adjusted to three stacked compartments or to two stacked compartments.

The container has adhesive pads under the lid using which the left lid and the right lid can be secured to each other. The lids also have slots for the coupler of the container, which connects to the retractable suspension device and in the hood. The lids can have more than slot for the coupler, as the position of the coupler of the container can change depending on whether the container is two layered container or a three layered container.

FIG. 13B illustrates a hex-box container for delivering food, consistent with various embodiments. The hex-box container in FIG. 13B shows a pair of wine bottles housed in the slots in the bottom-most compartment of the container. The hex-box can be configured to carry one or more drinks. For example, the hex-box will have a single slot for carrying one drink and two slots for two drinks. The shape and size of the slots can vary and depends the shape and size of the drink containers to be carried. FIG. 13B also illustrates how the hex-box container fits into the hood.

Note that the configuration of the container, e.g., shape, size, the number of compartments, are completely configurable and is not restricted to the illustrated embodiments.

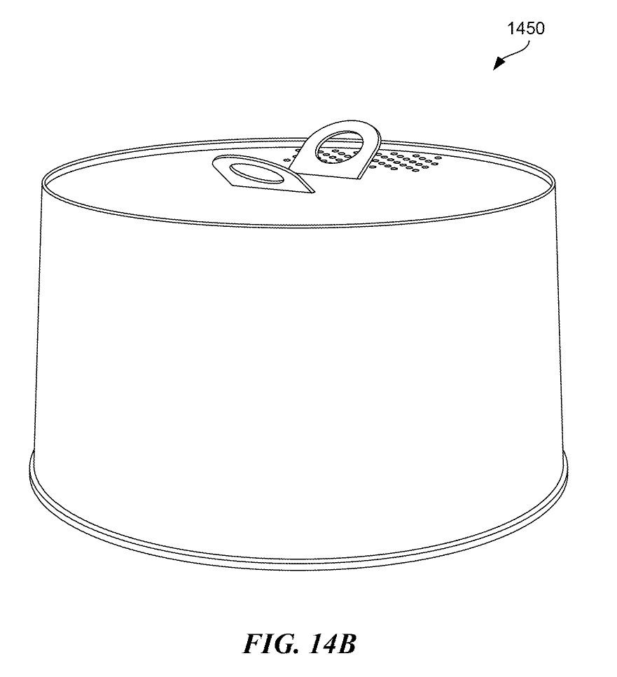

FIGS. 14A-14B illustrate a container configured for drone delivery, according to an embodiment. FIGS. 14A and 14B, collectively referred to as FIG. 14, is a block diagram of a container 1400, consistent with various embodiments. The container 1400 can be round or round-like, e.g., elliptical, conical, in shape. In some embodiments, the shape of the container 1400 can be representative of a bucket. The container 1400 has a removable lid 1450, which can be cylindrical, as illustrated in FIG. 14B. The container 1400, like the container 1300 of FIG. 8, can include various compartments for carrying various types of food, e.g., liquid food, solid food, hot food and/or cold food. The compartments can be designed such that when a set of food items are placed, the container 1400 is well balanced, e.g., weight is centered. For example, as illustrated in FIG. 14A, the two compartments for holding liquids, e.g., drinks, are located diametrically opposite to each other in the container 1400 so as to center the weight. The container 1400 can also include a compartment for carrying various types of cutlery.

The container 1400 can have means for facilitating a customer to hold or carry the container. For example, the container 1400 includes a pair of finger grips into which the customer can slip in his/her fingers and carry the container 1400. The finger grips can be affixed to the container 1400, or the lid 1450 of the container 1400 if the lid 1450 of the container 1400 can be locked/secured to the container 1400.

In some embodiments, the container 1400 is modular, e.g., can be made using a number of card plates, e.g., made out of cardboard, paper and/or other suitable material. The card plates (not illustrated) can have fold lines, slotted lines and/or slots along which one can fold the card plates to form the container 1400 or a portion thereof. The card plates can then be assembled together to form the container 1400.

The container 1400 (or even container 1300) can be configured to pick up and/or drop items other than food, e.g., goods such as electronics, apparel, shoes. The container 1400 can be configured to have various types of compartments based on the type of the goods that have to be picked up/delivered. In some embodiments, the container 1400 has foam or other similar material in the base, as illustrated in FIG. 10A. The foam-based base can serve various purposes. For example, the foam-based base can hold the packages placed in the container 1400 in a stable position by minimizing the movement of the package during the flight. In another example, the foam-based base can provide additional cushion between a soft outer layer of cardboard of the base of the container 1400 and a potentially hard inner object such as a bottle of wine which makes it safer if the container 1400 falls off the drone and hits a person or property. The foam-based base enables delivering of a variety of shaped objects whether rectangular, triangular, elliptical, etc. (provided they can fit in the container 1400, and be held in position by the foam-based base). For example, if a box containing a pair of shoes is to be delivered, the box would be placed inside the container 1400, it would be held in position by foam, and then the container 1400 holding the box could be picked up to the drone; then delivered at the destination.

In some embodiments, the container 1400 has no corners or edges on the exterior surface of the container 1400. The container 1400 can have a spherical underside with a flat bottom that eliminates corners/edges. The corners can be rounded as illustrated in FIG. 10A. With the rounded corners, if the container 1400 falls from the drone and hits a person, the round corners/edges of the exterior deforms more than a straight edged corner/edge and is therefore, safer as the impact on the person is minimized.

The container packaging is designed so it can carry a variety of different product sizes including parcels and fast food with none-to-minimum changes to the container (besides adding inserts to ensure the goods that are delivered have a snug and insulated fit so they don't roll around and are kept at the correct temperature). The container can include variable padding based on the center of gravity of the drone, e.g., padding is thickest where the center of gravity is of greatest which makes it safer for people upon impact when the container crash lands on people. The hood can also cover the container in foam, which provides an additional safety measure. For example, if the retractable suspension device 135 is severed and when the container falls, in the event of an impact with a person, the container hits the person with the foam rather than with a corner or edge, which makes it safer.

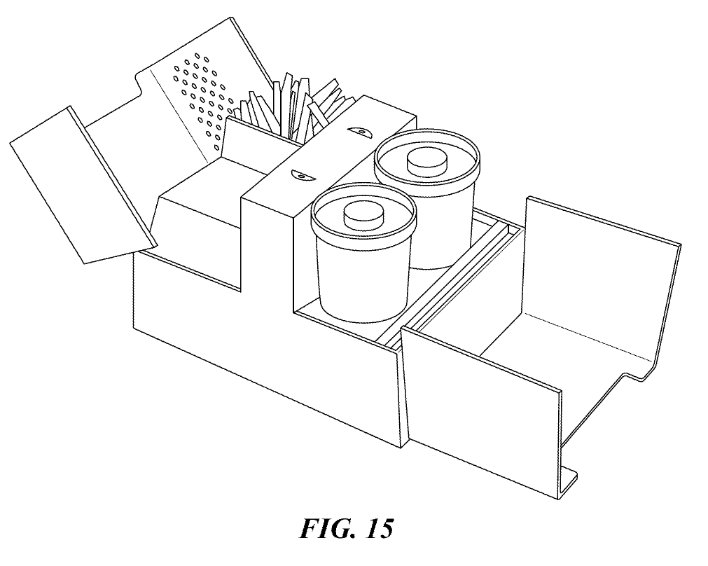

FIG. 15 illustrates a container configured for drone delivery, according to an embodiment. The container is a rectangular or square shaped container configured to carry a beverage. The container has slots for carrying two beverages, e.g., wine bottle, fast food cup, etc. Also, the beverages in the container can be wrapped with an insulating layer to keep the beverages at a constant temperature or to minimize the temperature change. The container also has a slot for placing the coupler, which is used to attach the container to the retractable suspension device 135 of the drone.

FIGS. 16A-16G, collectively referred to as FIG. 16, illustrate a coupling mechanism 140 for the container, according to an embodiment. FIG. 16A shows a coupling mechanism including an inserting member 142 and a receiving member 144. The inserting member is attached to a suspension mechanism 135. The suspension mechanism 135 can be controlled by a drone to lower and/or raise the inserting member 142.

The receiving member can be affixed to a top wall of a container 1600. The receiving member can include a plurality of protruding elements (e.g., four protruding elements). The plurality of protruding elements can be evenly spaced around an a surface of an opening in the receiving member. The plurality of protruding elements can be, for example, square shaped or circle shaped. A shape of the protruding elements can correspond with a shape of a hook element of the inserting member 142.

FIG. 16B illustrates an inserting member 142, according to an embodiment. The inserting member includes a plurality of hook elements 1620 (e.g., four hook elements). An upper portion of any of the hook elements can include a slanted appendage 1624. The slanted appendage 1624 can be affixed to an outer surface of the inserting member 142. The slanted appendage 1624 can include a lower surface 1626 sloped toward a hooked portion 1622 of the hook element 1620. The lower surface 1626 of the slanted appendage 1624 can be connected to the hooked portion 1622 such that a continuous surface extends from the lower surface 1626 to the hooked portion 1622. The lower surface 1626 can be slanted upward extending from a first side of the hooked portion 1622 to a second side of the hooked portion 1622.

In an embodiment, a top terminal end of the lower surface 1626 extends beyond a second side of the hooked portion 1622 or is in line with the second side of the hooked portion 1622. If the inserting member 142 is inserted into a receiving member 144, protruding elements of the receiving member can glide along the lower surface 1626 causing the inserting member 142 to rotate out into an out-of-alignment position. An out-of-alignment position includes the protruding element not being above the hooked portion 1622.

Since the lower surface 1626 causes the protruding elements to be shifted out of alignment with the hooked portion 1622 if the inserting member is inserted a threshold distance into the receiving member 144, the threshold distance can be utilized to unlock the inserting member from the receiving member 144. For example, a drone having a cable connected to the inserting member 142 can allow slack to develop in the cable causing the inserting member 142 to enter the receiving member 144 beyond a threshold distance causing the out-of-alignment position. Since the hooks are not in position to attach the protruding elements in the out-of-alignment position, the drone can then retract the cable and bring the inserting member 142 up to the drone while leaving the receiving member 144 with the container.

FIG. 16C illustrates the receiving member 144. An opening in an upper surface of the receiving member 144 can receive the inserting member 142. A sidewall of the opening of the receiving member can include one or more protruding elements (e.g., four protruding elements). The one or more protruding elements can be configured to be secured by a hook element (e.g., hook element 1620 of FIG. 16B). For example, the one or more protruding elements can have an approximately square shape with a corner pointing downward and one or more complimentary hook elements can have a V-shaped sidewall to clasp onto the protruding element. In an example, the one or more protruding elements can have an approximately round shape and one or more complimentary hook elements can have a curved sidewall.

FIGS. 16D-16F illustrate the inserting member 142 inserted into the receiving member 144 from various perspectives. FIG. 16D shows an orthogonal view of the inserting member 142 inserted into the receiving member 144. FIG. 16E is a top down view of the inserting member 142 inserted into the receiving member 144. FIG. 16F is a side view of the inserting member 142 inserted into the receiving member 144. A side of the receiving member 144 is shown as substantially transparent to show a position of the inserting member 142 within an opening of the receiving member. Various embodiments including opaque sides for the inserting member 142 are contemplated.

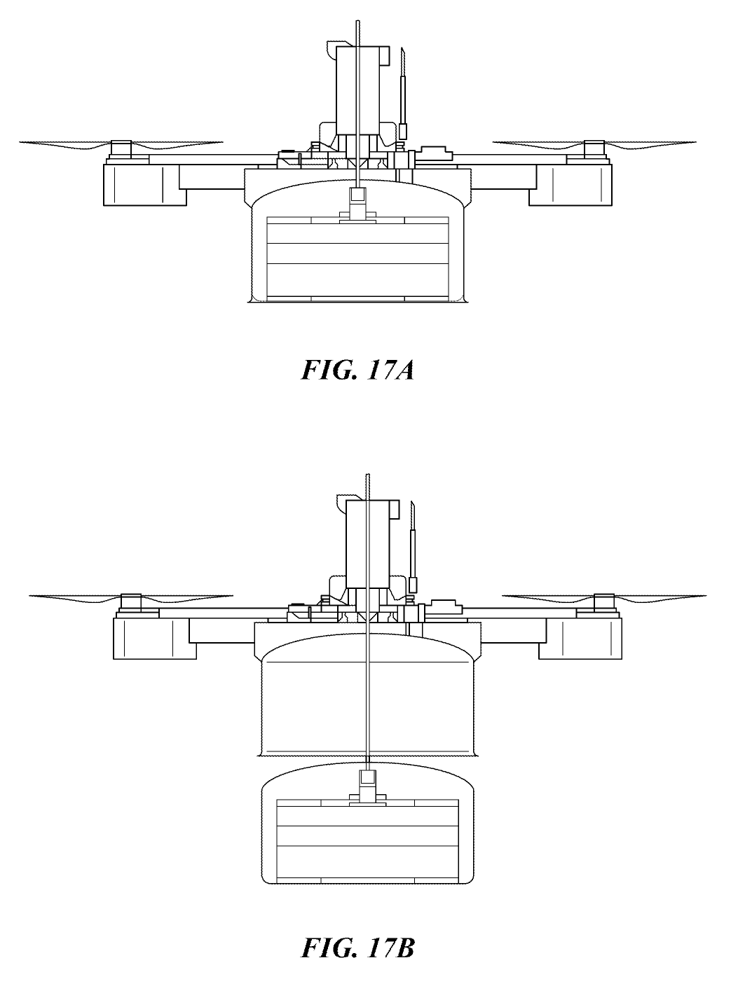

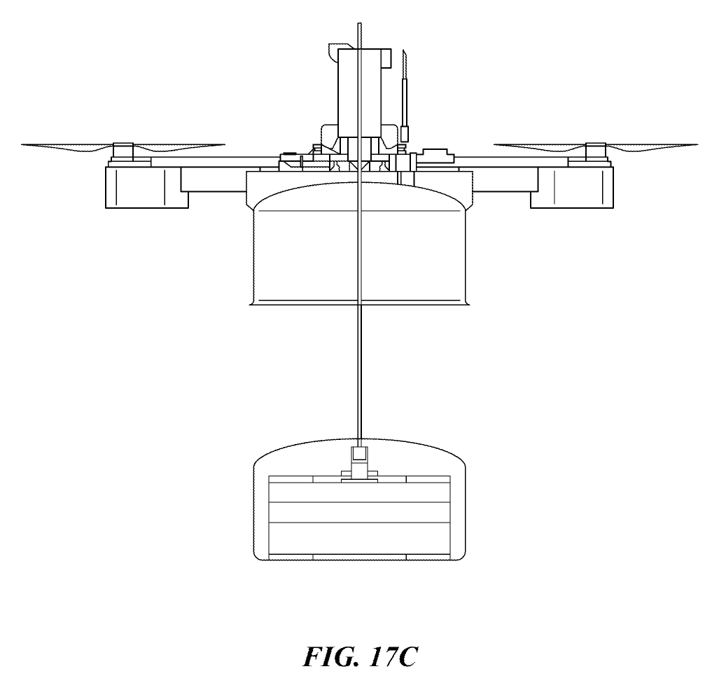

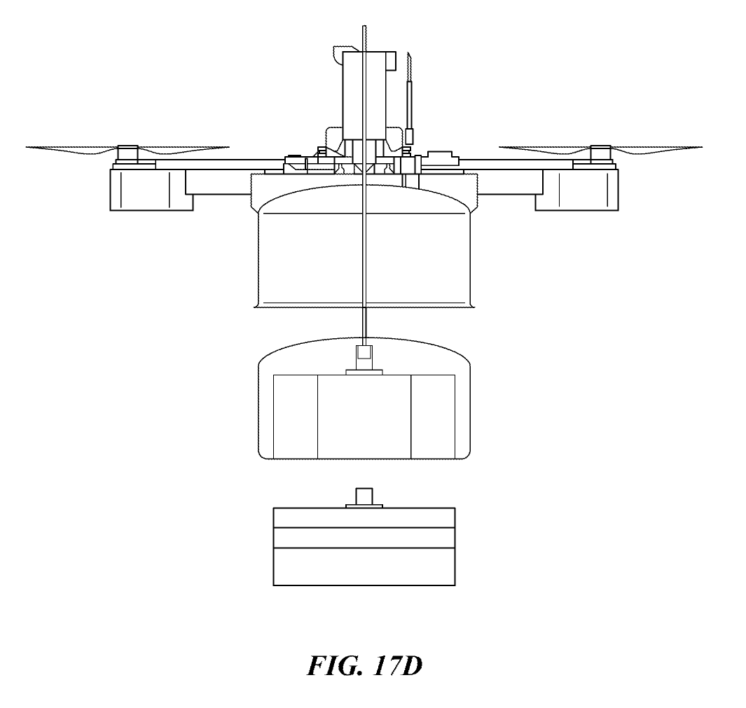

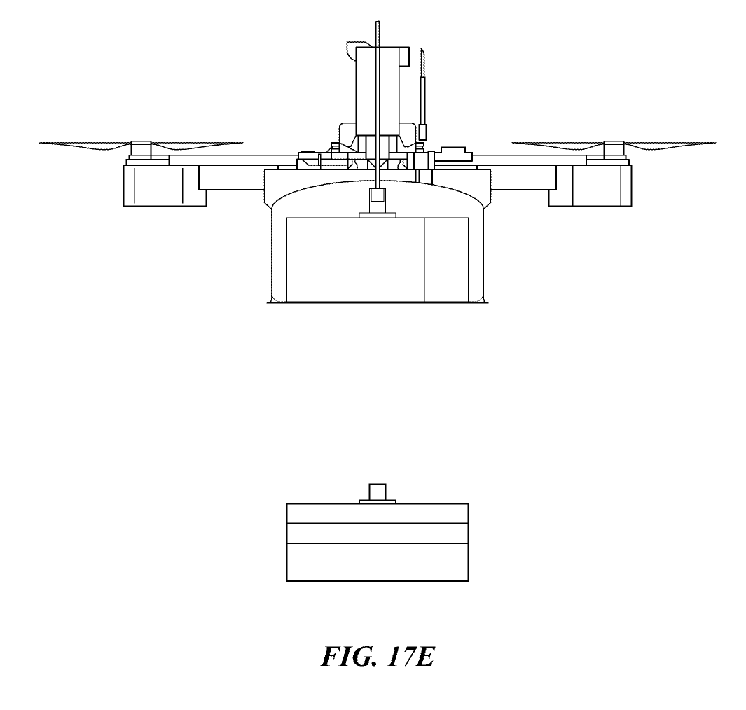

FIGS. 17A-17E, collectively referred to as FIG. 17, is a block diagram illustrating an example of delivering a package using a drone, consistent with various embodiments. The example can be implemented in the system 100 of FIG. 1 and using the drone. In some embodiments, the example is similar to the example 200 illustrated in FIG. 2. FIG. 17A illustrates the drone en route to deliver the package, consistent with various embodiments. In some embodiments, the package is similar to any of the containers illustrated in FIGS. 1-15. In some embodiments, the package is attached to the drone via the retractable suspension device 135 and is locked to the retractable suspension device 135 via a coupling mechanism 140, e.g., the coupling mechanism 140. In some embodiments, the coupling mechanism 140 can be gravity activated.

Upon reaching the delivery destination, the drone prepares to lower the package at a delivery area in the delivery destination. As illustrated in FIG. 17B, the drone while hovering at the delivery area at a particular height from the ground, lowers the retractable suspension device 135 to deliver the package. The hood is lowered to deliver the package. While FIG. 17B illustrates the package being visible from outside the hood, note that the package can be concealed in the hood. The drone continues to lower the retractable suspension device 135 until the package rests on the delivery area, as illustrated in FIG. 17C. When the package rests on the delivery area, e.g., the ground, the coupling mechanism 140 disengages thereby releasing the package. When the package rests on the delivery area, the weight of the package is offloaded from coupling mechanism 140, which results in the gravitational force exerted on the coupling mechanism 140 to drop below a specified value, thereby causing the coupling mechanism 140 to disengage.

After the package is delivered in the delivery area and released from the coupling mechanism 140, the drone retracts the hood as illustrated in FIG. 17D. The drone continues to retract until the hood is secured into the container housing, as illustrated in FIG. 17E.

The configuration of the hood and the container housing can enable self-aligning retraction of the package, which enables the package delivery mechanism to perform pickups in addition to deliveries. The self-aligning retraction can also facilitate mid delivery aborts, e.g., aborting delivery midway and retracting the package back to the container housing. The packages can be picked up from or delivered to consumers while the drone is in hover.

Also, since the hood lowers with the package, in some embodiments, if the suspension mechanism is severed, the likelihood of the package landing on its edge on someone is reduced significantly and therefore it is safer. Also the hood can keep the hot food hot on its the way to the destination. Further, since the package is concealed in the hood, after the package is lowered to the ground the hood lifts away to reveal the package, which provides and “abracadabra moment,” a magical effect of the package appearing all of a sudden.

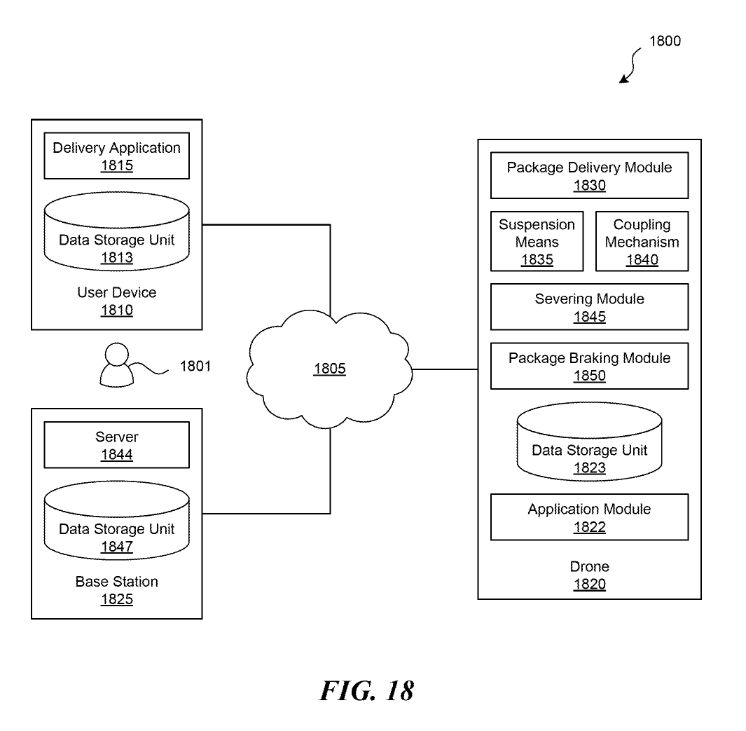

FIG. 18 is a block diagram illustrating a system 1800 to deliver a package using a drone, consistent with various embodiments. The system 1800 includes a user device 1810, the drone, and a base station 1825 that are configured to communicate with one another via a network 1805. The network 1805 can include a local area network (“LAN”), a wide area network (“WAN”), an intranet, an Internet, a cellular or other mobile communication network, Bluetooth, near field communication (NFC), or any combination thereof. The user device 1810 can include a desktop computer, a laptop computer, a tablet computer, a smart phone, a wearable device or an automobile with one or more processors embedded therein, or any other wired or wireless, processor-driven device. The user device 1810 can be used by a user 1801, e.g., a recipient of the package, to track the status of the package delivery made by the drone, and/or place an order for a product and request that it be shipped using a drone. The base station 1825 can include a server, a desktop computer, a laptop computer, a tablet computer, a smart phone, or any other wired or wireless, or a processor-driven device that can be used by operators of the drone for operating the drone to deliver the package.

In some embodiments, the user 1801 may have to install an application, e.g., a delivery application 1815, on the user device 1810 to access various features provided by the delivery service, including delivery status of the package. In some embodiments, the user 1801 may also log into a website provided by the merchant and/or the drone operator to access the above features. The user device 1810 can include a data storage unit 1813. The data storage unit 1813 can store data that may be necessary for the working of the delivery application 1815. For example, the data storage unit 1813 can store data regarding the delivery status of the package. In another example, the data storage unit 1813 can store information such as specific delivery instructions provided by the user to the operators of the drone. In some embodiments, the user 1801 may access the delivery application 1815 on the user device 1810 via a user interface. The user 1801 can sign in to the delivery application 1815 and communicate with the base station 1825 to arrange for, modify, or cancel the delivery of a product.

The base station 1825 can include a server 1844 and a data storage unit 1847. The base station 1825 can communicate with the user device 1810, merchant systems, or other package delivery systems that deliver or receive packages. The base station 1825 may represent any system that delivers or receives packages. For example, the base station 1825 may be a courier, a shipping company, a postal service, a merchant system of a merchant with whom the user 1801 performed a transaction to buy a product that is being delivered, or another party who is operating the drone on behalf of the merchant or the delivery service provider to deliver the product to the user 1801.

The drone may be any type of UAV, e.g., a helicopter, a quadcopter, other multi-rotor, or a fixed-wing UAV. The drone includes an application module 1822 that facilitates the drone 1820 to deliver a package to the user 1801. The application module 1822 can include the hardware and/or software for working with a package delivery module 1830, retractable suspension device 135 1835 and a coupling mechanism 140 1840 to deliver the package to the user 1801 at a delivery destination. The application module 1822 can receive instructions for package deliveries, e.g., from the base station 1825. For example, the application module 1822 may receive delivery addresses, GPS locations, delivery route, package details, or other delivery information. The application module 1822 may store the received information, and other suitable data to be used for facilitating the delivery of the package in the data storage unit 1823.

A package to be delivered to the user 1801 can be attached to the drone using the package delivery module 1830. The package delivery module 1830 includes a retractable suspension device 1835, e.g., a cable, to which the package can be attached. The retractable suspension device 1835 can be made of any suitable material, e.g., a metal, a metal alloy, microfilament. In some embodiments, the retractable suspension device 1835 is made of microfilaments in a braided line. In some embodiments, the retractable suspension device 1835 is the same as or similar to a fishing cable wire. In some embodiments, the retractable suspension device 1835 is made of a material than can be severed by the application of heat, e.g., within a specified duration. One end of the retractable suspension device 1835 is attached to the drone at the package delivery module, and another end to a coupling mechanism 1840 to which the package can be attached. In some embodiments, the retractable suspension device 1835 is wound like a coil onto a spindle in the package delivery module 1830 though other configurations are possible. The package is attached to the coupling mechanism 1840, which locks the package to the retractable suspension device 1835. After the package is affixed to the drone, the base station 1825 instructs the drone to fly to the delivery destination. Upon reaching the delivery destination, the drone prepares to lower the package on a delivery area at the delivery destination. The drone begins to hover in air at the delivery destination at a particular height from the ground, and the package delivery module 1830 instructs the retractable suspension device 1835 to lower the attached package from the drone onto the delivery area on the ground. After the package rests on the delivery area, the coupling mechanism 1840 disengages and releases the package. The package delivery module 1830 then retracts the retractable suspension device 1835 onto the drone.

In some embodiments, the coupling mechanism 1840 is gravity activated, that is, engages when a gravitational force exerted on the coupling mechanism 1840 due to the weight of the package is beyond a first specified value, and disengages when the gravitational force on the coupling mechanism 1840 drops below a second specified value, e.g., when the weight of the package is taken off the coupling mechanism 1840.

The drone also includes a severing module 1845 to sever the retractable suspension device 1835, e.g., to keep the drone from crashing and causing damage in situations such as when the retractable suspension device 1835 is grabbed onto and pulled by a person and/or an animal, or if the cable is tangled in an obstacle like a tree. On severing, the retractable suspension device 1835 separates from the drone thereby precluding the drone from being dragged down. In some embodiments, the package delivery module 1830 determines whether to sever the retractable suspension device 1835 based on an additional load on the retractable suspension device 1835. When the retractable suspension device 1835 is pulled, there typically will be an increase in load on the retractable suspension device 1835. The package delivery module 1830 can detect the additional load on the retractable suspension device 1835, and if the total load/weight is beyond a specified value, the package delivery module 1830 can instruct the severing module 1845 to sever the retractable suspension device 1835 from the drone. In some embodiments, the severing module 1845 includes a nichrome wire for severing the retractable suspension device 1835. For example, a portion of the retractable suspension device 1835 can be wound with the nichrome wire, and when an electric current of certain rating is passed through the nichrome wire, the nichrome wire generates significant heat around the wire, thereby severing the retractable suspension device 1835. In some embodiments, the retractable suspension device 1835 is made of a material that can be severed using heat. In some embodiments, the severing module uses other cutting instruments to sever the retractable suspension device 1835.

The drone includes a package brake module 1850 that locks the package to the drone and keeps the package from being removed by unauthorized personnel in case there is a problem with the drone, e.g., a power failure in the drone, or with the package delivery module 1830, e.g., retractable suspension device 1835 is not working.

Note that the drone illustrated in FIG. 18 is not restricted to having the above modules. The drone can include lesser number of modules, e.g., functionalities of two modules can be combined into one module. The drone can also include more number of modules, e.g., functionalities performed by a single module can be performed by more than one module, or there can be additional modules that perform other functionalities. The functionality performed by a module described above can be performed by one or more of the other modules as well. Further, the drone can include other modules for performing, or the application module 1822 can be further configured to perform other functions including: controlling the drone in flight, detecting errors in operation of the drone, deploying a parachute to decelerate the descent of the drone, providing power supply to the drone, steering the drone, disabling the motors of the drone, navigating the drone, including providing route information or adjusting the route information dynamically, capturing an image, an audio clip, and/or a video clip of various targets from the drone, preventing unauthorized interference with the command and control of the drone, deploying an airbag to minimize a damage that can be caused to the drone in case of a crash.

The drone can be deployed to perform one or more applications, e.g., surveillance of illegal activities to safeguard civil security, anti-poacher operations, forest fire fighting, monitoring flooding storms & hurricanes, traffic monitoring, radiation measurement, searching for missing persons, monitoring harvesting. The application module 1822 can be configured to perform a specified user-defined application.

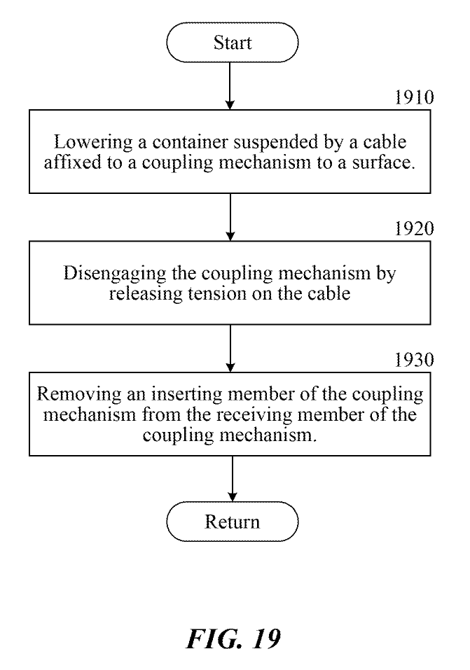

FIG. 19 is a flow diagram of a method for using the container, according to an embodiment. The method can include lowering the container suspended by a cable affixed to a coupling mechanism to a surface (step 1910), disengaging the coupling mechanism by releasing tension on the cable (step 1920), and removing an inserting member of the coupling mechanism from the inserting member of the coupling mechanism (step 1930).

Step 1910 can involve lowering a container suspended by a cable affixed to a coupling mechanism to a surface (e.g., the ground, a patio, a balcony, etc.). The container can include a plurality of sidewalls affixed to a top wall. The plurality of sidewalls can include securing mechanisms to be affixed to a bottom wall. One or more rigid extremities can extend from any of the plurality of sidewalls. The coupling mechanism can extends through an aperture in the top wall of the container. The coupling mechanism is configured to engage based on an applied tension. The coupling mechanism can include a receiving member and an inserting member. The receiving member can be affixed to the top wall of the container. The inserting member is attachable to the receiving member and affixed to a cable (e.g., a cable affixed to a drone). The receiving member includes one or more protruding elements in an opening of the receiving member. The inserting member includes one or more hook elements configured to clasp the protruding elements if the hook elements and protruding elements are in alignment. An upper slanted portion of the hook element causes the hook elements and protruding elements to be out of alignment if the inserting member enters the receiving member a distance greater than a threshold distance.

Step 1920 can involve disengaging the coupling mechanism. The coupling mechanism can be disengaged by releasing tension on the cable. Releasing tension on the cable can cause a slanted extension of the coupling mechanism to misalign a hook element and a protruding element of the coupling mechanism. If the tension is released, the inserting member sinks further into the receiving mechanism. At a threshold distance into the receiving mechanism, the protruding element comes in contact with the slanted extension (e.g., an upper portion of the hook element as shown in FIG. 16B). When the protruding element comes in contact with the slanted extension, the inserting member rotates so that the hook element is out of alignment with the protruding element. Once the hook element and protruding element are out of alignment, the inserting member can be removed (e.g., by re-applying a tension to the cable) without the hook element clasping the protruding element.

Step 1930 involves removing the inserting member from the inserting member. A drone affixed to one end of a cable (e.g., a top end of the cable) can re-apply a tension on the cable to lift the inserting member on another end of the cable (e.g., a bottom end of the cable) out of the receiving member. Since the inserting member has been rotated out of alignment (i.e. the hook element is out of alignment with the protruding element), the hook element will not clasp the protruding element as the protruding element is lifted out of the receiving member.

### Computer

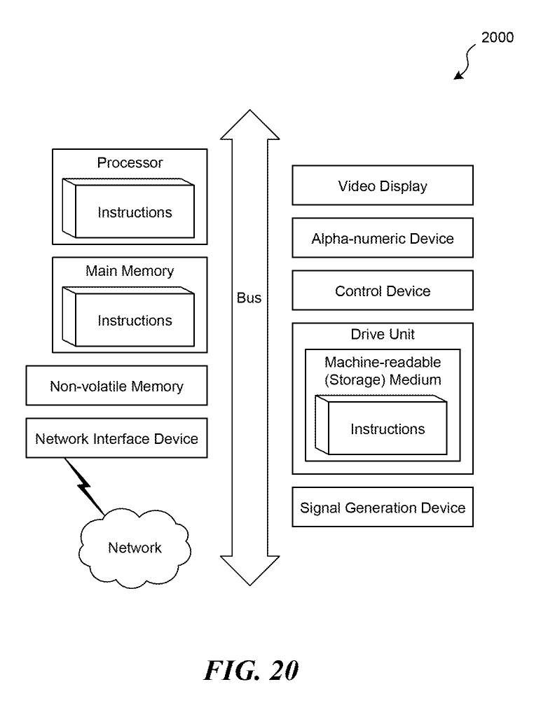

FIG. 20 is a diagrammatic representation of a machine in the example form of a computer system 2000 within which a set of instructions, for causing the machine to perform any one or more of the methodologies or modules discussed herein, can be executed.

In the example of FIG. 20, the computer system 2000 includes a processor, memory, non-volatile memory, and an interface device. Various common components (e.g., cache memory) are omitted for illustrative simplicity. The computer system 2000 is intended to illustrate a hardware device on which any of the components described in the example of FIGS. 1-5 (and any other components described in this specification) can be implemented. The computer system 2000 can be of any applicable known or convenient type. The components of the computer system 2000 can be coupled together via a bus or through some other known or convenient device.

This disclosure contemplates the computer system 2000 taking any suitable physical form. As example and not by way of limitation, computer system 2000 can be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, or a combination of two or more of these. Where appropriate, computer system 2000 can include one or more computer systems 2000; be unitary or distributed; span multiple locations; span multiple machines; or reside in a cloud, which can include one or more cloud components in one or more networks. Where appropriate, one or more computer systems 2000 can perform without substantial spatial or temporal limitation one or more steps of one or more methods described or illustrated herein. As an example and not by way of limitation, one or more computer systems 2000 can perform in real time or in batch mode one or more steps of one or more methods described or illustrated herein. One or more computer systems 2000 can perform at different times or at different locations one or more steps of one or more methods described or illustrated herein, where appropriate.

The processor can be, for example, a conventional microprocessor such as an Intel Pentium microprocessor or Motorola PowerPC microprocessor. One of skill in the relevant art can recognize that the terms “machine-readable (storage) medium” or “computer-readable (storage) medium” include any type of device that is accessible by the processor.

The memory is coupled to the processor by, for example, a bus. The memory can include, by way of example but not limitation, random access memory (RAM), such as dynamic RAM (DRAM) and static RAM (SRAM). The memory can be local, remote, or distributed.

The bus also couples the processor to the non-volatile memory and drive unit. The non-volatile memory is often a magnetic floppy or hard disk, a magnetic-optical disk, an optical disk, a read-only memory (ROM), such as a CD-ROM, EPROM, or EEPROM, a magnetic or optical card, or another form of storage for large amounts of data. Some of this data is often written, by a direct memory access process, into memory during execution of software in the computer system 2000. The non-volatile storage can be local, remote, or distributed. The non-volatile memory is optional because systems can be created with all applicable data available in memory. A typical computer system can usually include at least a processor, memory, and a device (e.g., a bus) coupling the memory to the processor.

Software is typically stored in the non-volatile memory and/or the drive unit. Indeed, storing an entire large program in memory may not be possible. Nevertheless, it should be understood that for software to run, if necessary, it is moved to a computer readable location appropriate for processing, and for illustrative purposes, that location is referred to as the memory in this paper. Even when software is moved to the memory for execution, the processor can typically make use of hardware registers to store values associated with the software, and local cache that, ideally, serves to speed up execution. As used herein, a software program is assumed to be stored at any known or convenient location (from non-volatile storage to hardware registers) when the software program is referred to as “implemented in a computer-readable medium.” A processor is considered to be “configured to execute a program” when at least one value associated with the program is stored in a register readable by the processor.

The bus also couples the processor to the network interface device. The interface can include one or more of a modem or network interface. It can be appreciated that a modem or network interface can be considered to be part of the computer system 2000. The interface can include an analog modem, ISDN modem, cable modem, token ring interface, satellite transmission interface (e.g., “direct PC”), or other interfaces for coupling a computer system to other computer systems. The interface can include one or more input and/or output devices. The I/O devices can include, by way of example but not limitation, a keyboard, a mouse or other pointing device, disk drives, printers, a scanner, and other input and/or output devices, including a display device. The display device can include, by way of example but not limitation, a cathode ray tube (CRT), liquid crystal display (LCD), or some other applicable known or convenient display device. For simplicity, it is assumed that controllers of any devices not depicted in the example of FIG. 20 reside in the interface.

In operation, the computer system 2000 can be controlled by operating system software that includes a file management system, such as a disk operating system. One example of operating system software with associated file management system software is the family of operating systems known as Windows® from Microsoft Corporation of Redmond, Wash., and their associated file management systems. Another example of operating system software with its associated file management system software is the Linux™ operating system and its associated file management system. The file management system is typically stored in the non-volatile memory and/or drive unit and causes the processor to execute the various acts utilized by the operating system to input and output data and to store data in the memory, including storing files on the non-volatile memory and/or drive unit.

Some portions of the detailed description can be presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or “generating” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The algorithms and displays presented herein are not inherently related to any particular computer or other apparatus. Various general purpose systems can be used with programs in accordance with the teachings herein, or it can prove convenient to construct more specialized apparatus to perform the methods of some embodiments. The utilized structure for a variety of these systems can appear from the description below. In addition, the techniques are not described with reference to any particular programming language, and various embodiments can thus be implemented using a variety of programming languages.

In alternative embodiments, the machine operates as a standalone device or can be connected (e.g., networked) to other machines. In a networked deployment, the machine can operate in the capacity of a server or a client machine in a client-server network environment, or as a peer machine in a peer-to-peer (or distributed) network environment.

The machine can be a server computer, a client computer, a personal computer (PC), a tablet PC, a laptop computer, a set-top box (STB), a personal digital assistant (PDA), a cellular telephone, an iPhone, a Blackberry, a processor, a telephone, a web appliance, a network router, switch or bridge, or any machine capable of executing a set of instructions (sequential or otherwise) that specify actions to be taken by that machine.

While the machine-readable medium or machine-readable storage medium is shown in an exemplary embodiment to be a single medium, the term “machine-readable medium” and “machine-readable storage medium” should be taken to include a single medium or multiple media (e.g., a centralized or distributed database, and/or associated caches and servers) that store the one or more sets of instructions. The term “machine-readable medium” and “machine-readable storage medium” shall also be taken to include any medium that is capable of storing, encoding or carrying a set of instructions for execution by the machine and that cause the machine to perform any one or more of the methodologies or modules of the presently disclosed technique and innovation.

In general, the routines executed to implement the embodiments of the disclosure, can be implemented as part of an operating system or a specific application, component, program, object, module or sequence of instructions referred to as “computer programs.” The computer programs typically comprise one or more instructions set at various times in various memory and storage devices in a computer, and that, when read and executed by one or more processing units or processors in a computer, cause the computer to perform operations to execute elements involving the various aspects of the disclosure.

Moreover, while embodiments have been described in the context of fully functioning computers and computer systems, those skilled in the art can appreciate that the various embodiments are capable of being distributed as a program product in a variety of forms, and that the disclosure applies equally regardless of the particular type of machine or computer-readable media used to actually effect the distribution.

Further examples of machine-readable storage media, machine-readable media, or computer-readable (storage) media include but are not limited to recordable type media such as volatile and non-volatile memory devices, floppy and other removable disks, hard disk drives, optical disks (e.g., Compact Disk Read-Only Memory (CD ROMS), Digital Versatile Disks, (DVDs), etc.), among others, and transmission type media such as digital and analog communication links.

In some circumstances, operation of a memory device, such as a change in state from a binary one to a binary zero or vice-versa, for example, can comprise a transformation, such as a physical transformation. With particular types of memory devices, such a physical transformation can comprise a physical transformation of an article to a different state or thing. For example, but without limitation, for some types of memory devices, a change in state can involve an accumulation and storage of charge or a release of stored charge. Likewise, in other memory devices, a change of state can comprise a physical change or transformation in magnetic orientation or a physical change or transformation in molecular structure, such as from crystalline to amorphous or vice versa. The foregoing is not intended to be an exhaustive list in which a change in state for a binary one to a binary zero or vice-versa in a memory device can comprise a transformation, such as a physical transformation. Rather, the foregoing is intended as illustrative examples.

A storage medium typically can be non-transitory or comprise a non-transitory device. In this context, a non-transitory storage medium can include a device that is tangible, meaning that the device has a concrete physical form, although the device can change its physical state. Thus, for example, non-transitory refers to a device remaining tangible despite this change in state.

### Remarks

The foregoing description of various embodiments of the claimed subject matter has been provided for the purposes of illustration and description. It is not intended to be exhaustive or to limit the claimed subject matter to the precise forms disclosed. Many modifications and variations can be apparent to one skilled in the art. Embodiments were chosen and described in order to best describe the principles of the invention and its practical applications, thereby enabling others skilled in the relevant art to understand the claimed subject matter, the various embodiments, and the various modifications that are suited to the particular uses contemplated.

While embodiments have been described in the context of fully functioning computers and computer systems, those skilled in the art can appreciate that the various embodiments are capable of being distributed as a program product in a variety of forms, and that the disclosure applies equally regardless of the particular type of machine or computer-readable media used to actually effect the distribution.

Although the above Detailed Description describes certain embodiments and the best mode contemplated, no matter how detailed the above appears in text, the embodiments can be practiced in many ways. Details of the systems and methods can vary considerably in their implementation details, while still being encompassed by the specification. As noted above, particular terminology used when describing certain features or aspects of various embodiments should not be taken to imply that the terminology is being redefined herein to be restricted to any specific characteristics, features, or aspects of the invention with which that terminology is associated. In general, the terms used in the following claims should not be construed to limit the invention to the specific embodiments disclosed in the specification, unless those terms are explicitly defined herein. Accordingly, the actual scope of the invention encompasses not only the disclosed embodiments, but also all equivalent ways of practicing or implementing the embodiments under the claims.

The language used in the specification has been principally selected for readability and instructional purposes, and it cannot have been selected to delineate or circumscribe the inventive subject matter. It is therefore intended that the scope of the invention be limited not by this Detailed Description, but rather by any claims that issue on an application based hereon. Accordingly, the disclosure of various embodiments is intended to be illustrative, but not limiting, of the scope of the embodiments, which is set forth in the following claims.

What is claimed is:

1. A container, comprising:
a plurality of sidewalls affixed to a top wall;
a rigid extremity having a contiguous surface with a sidewall among the plurality of sidewalls and extending below a lower surface of the plurality of sidewalls, wherein the rigid extremity includes a malleable contour proximate to a corner of the container, and wherein the malleable contour extends from a base of the rigid extremity through the sidewall; and
an aperture in the top wall configured for a receiving member of a coupling mechanism.

2. The container of claim 1, wherein the receiving member includes an opening having at least one protruding element extending from a surface of the opening.

3. The container of claim 2, wherein the receiving member is configured to attach to an inserting member having a tension and detach if the tension terminates.

4. The container of claim 3, where the inserting member includes a plurality of hook elements having a hooked portion and a slanted extension, wherein the protruding elements of the inserting member attach to the hook elements if the hooked portion is in line with the protruding elements, and wherein the slanted extension causes the hooked portion to be out of alignment with the protruding elements if the tension terminates.

5. The container of claim 1, wherein the coupling mechanism comprises any of a lock, a latch, a humanoid clasping device, a tension-dependent locking mechanism, and a magnetic locking mechanism.

6. The container of claim 1, wherein the receiving member is configured to securably attach and detach from the inserting member.

7. The container of claim 1, further comprising:
a multifunction layer affixed to one or more sidewalls including any combination of a faraday cage, a thermal insulation layer, and a hydrophobic coating.

8. The container of claim 1, further comprising:
a hydrophobic coating affixed to the plurality of sidewalls and the top wall.

9. The container of claim 1, further comprising:
a thermal insulation layer integrated into the sidewall, internal packaging components, or combination thereof.

10. The container of claim 1, further comprising:
a faraday cage integrated into internal packaging components of the container.

11. The container of claim 1, further comprising:
internal packing components affixed to a bottom wall and configurable into at least a first arrangement and a second arrangement by insertion into pre-cut slits in the bottom wall.

12. The container of claim 1, further comprising:
internal packaging components including a configurable compartment and a partial shelf, wherein an upper surface of the configurable compartment is in line with an upper surface of the partial shelf.

13. The container of claim 1, wherein one or more components of the container are frangible.

14. The container of claim 1, wherein the rigid extremity implodes upon an impact force exceeding a threshold.

15. The container of claim 1, further comprising:
one or more securing mechanisms affixing the sidewall to a bottom wall, wherein the one or more securing mechanisms disengage upon an impact force exceeding a threshold causing the container to fail.

16. The container of claim 1, further comprising:
another rigid extremity having a contiguous surface with the sidewall and extending below the lower surface of the plurality of sidewalls, wherein the another rigid extremity includes another malleable contour proximate to another corner of the container, and wherein the another malleable contour extends from a base of the another rigid extremity through the sidewall.

17. The container of claim 1, further comprising:
a pair of rigid extremities having a contiguous surface with another sidewall among the plurality of sidewalls and extending below the lower surface of the plurality of sidewalls, wherein the pair of rigid extremities include a corresponding pair of malleable contours proximate to corners of the container, and wherein the pair of malleable contours extend from bases of the pair of rigid extremities through the another sidewall.

18. The container of claim 1, wherein the malleable contour is configured to provide a rounded surface along the corner of the container.

19. The container of claim 1, wherein one or more container components are modular to conform to receivable objects of one or more sizes.

20. A container for drone deliver, comprising:
a plurality of sidewalls affixed to a top wall, wherein any of the plurality of sidewalls includes a securing mechanism to affix to a bottom wall;
a pair of rigid extremities having a contiguous surface with a sidewall among the plurality of sidewalls and extending below a lower surface of the plurality of sidewalls, wherein the pair of rigid extremities includes a corresponding pair of malleable contours proximate to corners of the container, and wherein the corresponding pair of malleable contours extend from bases of the pair of rigid extremities through the sidewall; and
a coupling mechanism extending through an aperture in the top wall, the coupling mechanism configured to engage and disengage based on an applied tension.

21. The container of claim 20, further comprising:
internal packing components affixed to a bottom wall and including a configurable compartment and a partial shelf, wherein the configurable compartment can be configured in at least a first arrangement and a second arrangement by insertion into pre-cut slits in the bottom wall, and wherein an upper surface of the configurable compartment is in line with an upper surface of the partial shelf.

22. The container of claim 20, further comprising:
a multifunction layer affixed to one or more sidewalls including any combination of a faraday cage, a thermal insulation layer, and a hydrophobic coating.

23. The container of claim 20, wherein the securing mechanism disengages upon an impact force exceeding a threshold causing the container to fail.

24. The container of claim 20, further comprising:
a cable affixed to the coupling mechanism configured to apply a tension to the container and suspend the container in the air.

25. The container of claim 24, wherein the cable is retractable into a drone.

26. The container of claim 20, further comprising:
another pair of rigid extremities having a contiguous surface with another sidewall among the plurality of sidewalls and extending below the lower surface of the plurality of sidewalls, wherein the another pair of rigid extremities include another corresponding pair of malleable contours proximate to corners of the container, and wherein the another pair of malleable contours extend from bases of the another pair of rigid extremities through the another sidewall.

27. A method of releasing a container, comprising:
lowering a container suspended by a cable affixed to a coupling mechanism to a surface, the container including a plurality of sidewalls affixed to a top wall, wherein the coupling mechanism extends through an aperture in the top wall of the container, and wherein the coupling mechanism is configured to engage based on an applied tension; and
disengaging the coupling mechanism by releasing tension on the cable to cause a slanted extension of the coupling mechanism to misalign a hook element and a protruding element of the coupling mechanism.

28. The method of claim 27, wherein the coupling mechanism includes an inserting member having the hook element and a receiving member having the protruding element.

29. The method of claim 28, wherein the coupling mechanism is engaged if the hook element is wrapped around the protruding element and disengaged when the hook element and protruding element are misaligned.

30. The method of claim 27, wherein the container further comprises:
a rigid extremity having a contiguous surface with a sidewall among the plurality of sidewalls and extending below a lower surface of the plurality of sidewalls, wherein the rigid extremity includes a malleable contour proximate to a corner of the container, and wherein the malleable contour extends from a base of the rigid extremity through the sidewall.

31. The method of claim 30, wherein the rigid extremity of the container absorbs an impact from lowering the container to the surface.
